(19) United States
(12) Patent Application Publication
(10) Pub. No.: US 2025/0355713 A1
(43) Pub. Date: Nov. 20, 2025

(54) TASK GENERATION METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Zhiqiang DONG, Shenzhen (CN); Shufan DENG, Shenzhen (CN)

(21) Appl. No.: 19/281,737

(22) Filed: Jul. 27, 2025

Related U.S. Application Data
(63) Continuation of application No. PCT/CN2023/127268, filed on Oct. 27, 2023.

(30) Foreign Application Priority Data
May 31, 2023 (CN) 202310645825.8

(51) Int. Cl. G06F 9/50

(52) U.S. Cl. CPC G06F 9/5027

(57) ABSTRACT

A task generation method performed by a computer device includes: obtaining task requirement information inputted based on a task generation interface; calling a large language model, and inputting the task requirement information into the large language model for performing semantic interpretation on the task requirement information and outputting an executable structural body of a target task that matches the task requirement information; performing graphic rendering on the target task based on the executable structural body of the target task, to obtain a task execution flowchart of the target task, and displaying the task execution flowchart in the task generation interface, the target task being formed according to one or more target atomic tasks; and displaying an execution progress viewing link of the target task in the task generation interface, the execution progress viewing link being configured for viewing an execution progress of the target task.

### CROSS-REFERENCES TO RELATED APPLICATIONS

This application is a continuation application of PCT application No. PCT/CN2023/127268, filed on Oct. 27, 2023, which claims priority to Chinese Patent Application No. 2023106458258, filed on May 31, 2023, all of which is incorporated herein by reference in their entirety.

### FIELD OF THE TECHNOLOGY

The present disclosure relates to the technical field of computer technologies, and in particular, to a task generation method based on a large language model, a task generation system based on a large language model, a computer device, a storage medium, and a computer program product.

### BACKGROUND OF THE DISCLOSURE

A workflow is a set of ordered tasks, activities, or steps used to accomplish one or more service processes or projects. These tasks or activities are performed in a certain order and according to certain rules, and may be executed either automatically or manually. Workflows may help organizations or businesses improve efficiency, optimize business processes, reduce costs, and improve productivity and quality. Workflows are usually managed and executed by some workflow engines or software.

However, current users need to use computers to complete a workflow task, which often requires complex operations, including analyzing a problem, designing a flow, writing code, setting up an execution environment, executing the code, and the like. These operations involve very cumbersome processes, with problems of complex operations, low efficiency, and high costs.

### SUMMARY

One embodiment of the present disclosure provides a task generation method, performed by a computer device. The method includes: obtaining task requirement information inputted based on a task generation interface; calling a large language model, and inputting the task requirement information into the large language model for performing semantic interpretation on the task requirement information and outputting an executable structural body of a target task that matches the task requirement information; performing graphic rendering on the target task based on the executable structural body of the target task, to obtain a task execution flowchart of the target task, and displaying the task execution flowchart in the task generation interface, the target task being formed according to one or more target atomic tasks; and displaying an execution progress viewing link of the target task in the task generation interface, the execution progress viewing link being configured for viewing an execution progress of the target task.

Another embodiment of the present disclosure provides a computer device. The computer device includes one or more processors and a memory containing computer-readable instructions that, when being executed, cause the one or more processors to perform: obtaining task requirement information inputted based on a task generation interface; calling a large language model, and inputting the task requirement information into the large language model for performing semantic interpretation on the task requirement information and outputting an executable structural body of a target task that matches the task requirement information; performing graphic rendering on the target task based on the executable structural body of the target task, to obtain a task execution flowchart of the target task, and displaying the task execution flowchart in the task generation interface, the target task being formed according to one or more target atomic tasks; and displaying an execution progress viewing link of the target task in the task generation interface, the execution progress viewing link being configured for viewing an execution progress of the target task.

Another embodiment of the present disclosure provides a non-transitory computer-readable storage medium containing computer-readable instructions that, when being executed, cause at least one processor to perform: obtaining task requirement information inputted based on a task generation interface; calling a large language model, and inputting the task requirement information into the large language model for performing semantic interpretation on the task requirement information and outputting an executable structural body of a target task that matches the task requirement information; performing graphic rendering on the target task based on the executable structural body of the target task, to obtain a task execution flowchart of the target task, and displaying the task execution flowchart in the task generation interface, the target task being formed according to one or more target atomic tasks; and displaying an execution progress viewing link of the target task in the task generation interface, the execution progress viewing link being configured for viewing an execution progress of the target task.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following descriptions show merely embodiments of the present disclosure, and a person of ordinary skill in the art may still derive other accompanying drawings from the disclosed accompanying drawings without creative efforts.

FIG. 1 is a diagram of an application environment of a task generation method based on a large language model according to an embodiment of the present disclosure.

FIG. 2 is a schematic flowchart of a task generation method based on a large language model according to an embodiment of the present disclosure.

FIG. 3A is a schematic diagram of an interactive task generation interface according to an embodiment of the present disclosure.

FIG. 3B is a schematic diagram of an interactive task generation interface according to another embodiment.

FIG. 3C is a schematic diagram of an execution progress viewing interface according to an embodiment of the present disclosure.

FIG. 4 is a schematic flowchart of an operation of determining a target atomic task according to an embodiment of the present disclosure.

FIG. 5 is a schematic diagram of a multilevel vector storage structure according to an embodiment of the present disclosure.

FIG. 6 is a schematic flowchart of generating an executable structural body of a target task according to an embodiment of the present disclosure.

FIG. 7 is a schematic diagram of a task instance message queue according to an embodiment of the present disclosure.

FIG. 8 is a schematic diagram of a sub-task instance message queue according to an embodiment of the present disclosure.

FIG. 9 is a schematic diagram of a global variable table according to an embodiment of the present disclosure.

FIG. 10 is a schematic flowchart of task execution according to an embodiment of the present disclosure.

FIG. 11 is a structural block diagram of a task generation system based on a large language model according to an embodiment of the present disclosure.

FIG. 12 is a diagram of an internal structure of a computer device according to an embodiment of the present disclosure.

### DESCRIPTION OF EMBODIMENTS

The technical solutions of the embodiments of the present disclosure will be described below clearly and comprehensively in conjunction with accompanying drawings of the embodiments of the present disclosure. Apparently, the embodiments described are merely some rather than all of the embodiments of the present disclosure. Based on the embodiments of the present disclosure, all other embodiments obtained by a person of ordinary skill in the art without creative efforts shall fall within the protection scope of the present disclosure.

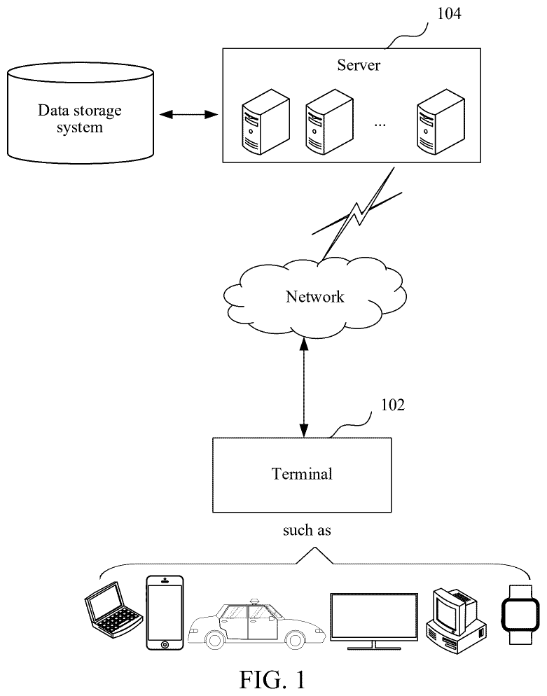

A task generation method based on a large language model provided in embodiments of the present disclosure may be applied to an application environment shown in FIG. 1. A terminal 102 communicates with a server 104 over a network. A data storage system may store data that the server 104 needs to process. The data storage system may be integrated on the server 104, or may be placed on the cloud or another server. The terminal 102 and the server 104 may cooperatively perform the task generation method based on a large language model, or the terminal 102 and the server 104 may independently perform the task generation method based on a large language model.

Descriptions are provided by using an example in which the terminal 102 and the server 104 cooperatively perform the task generation method based on a large language model. In some embodiments, the terminal 102 displays an interactive task generation interface, and sends task requirement information inputted in the interactive task generation interface to the server 104, and the server 104 obtains the task requirement information inputted based on the interactive task generation interface; the server 104 calls a large language model, inputs the task requirement information into the large language model, and performs semantic interpretation on the task requirement information by using the large language model, to output an executable structural body of a target task matching the task requirement information; the server 104 performs graphic rendering on the target task based on the executable structural body of the target task, to obtain a task execution flowchart of the target task, and the task execution flowchart is displayed in the task generation interface of the terminal 102, the target task being formed according to one or more target atomic tasks; and an execution progress viewing link of the target task is displayed in the task generation interface of the terminal 102, the execution progress viewing link being configured for viewing an execution progress of the target task.

The terminal 102 may be, but is not limited to, various personal computers, notebook computers, smartphones, tablet computers, Internet of Things devices, or portable wearable devices. The Internet of Thing device may be a smart speaker, a smart television, a smart air conditioner, a smart in-vehicle device, or the like. The portable wearable device may be a smart watch, a smart band, a head-mounted device, and the like. The server 104 may be implemented by using an independent server or a server cluster including a plurality of servers.

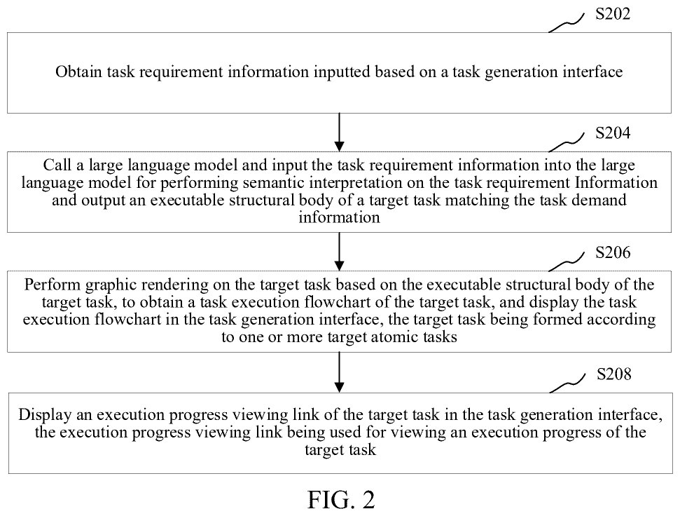

In an embodiment, as shown in FIG. 2, a task generation method based on a large language model is provided. An example in which the method is applied to a computing device (which may be the terminal 102 in FIG. 1, or the computer device 104 in FIG. 1) is configured for description, and the method includes the following operations:

Operation S202: Obtain task requirement information inputted based on an interactive task generation interface.

The task requirement information includes information about a to-be-generated task. The task requirement information refers to text information. The task may be understood as a workflow, and the workflow is a group of ordered activities or operations, and is configured for implementing one or more service processes or projects. These activities are performed according to a particular sequence and rule, and may be automatically or manually executed. The workflow may be executed by using a workflow execution engine, or may be managed by using software. Correspondingly, in a workflow scenario, the task requirement information is workflow requirement information.

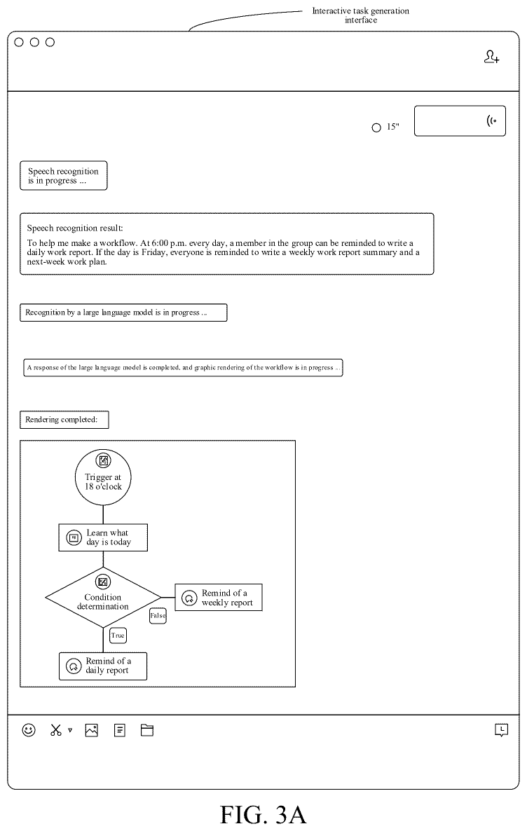

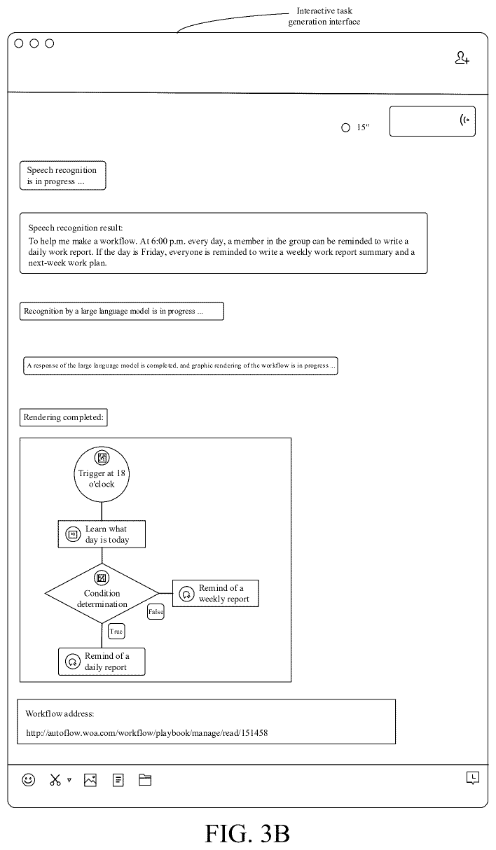

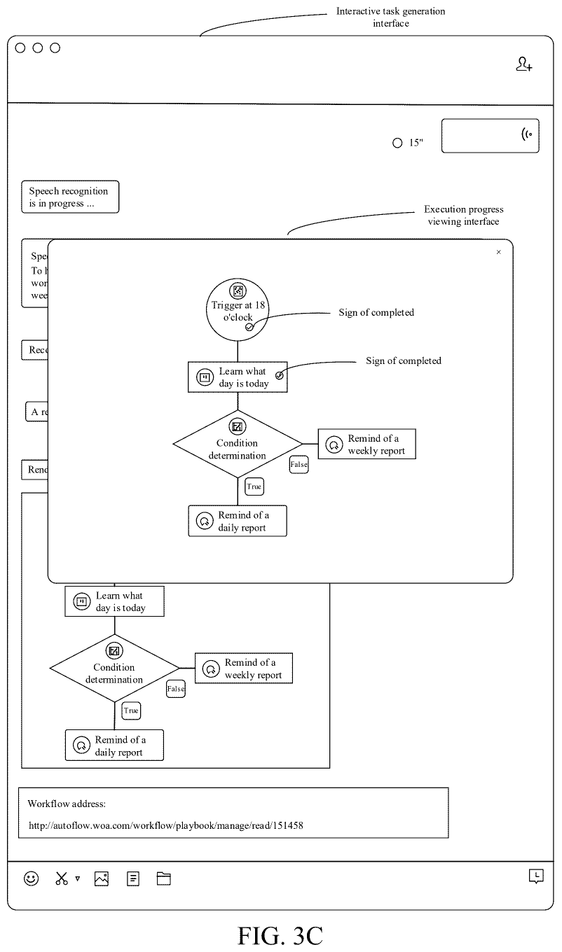

The interactive task generation interface is an interaction-type task generation interface, and the interactive task generation interface is an interface supporting human-machine interaction. The interactive task generation interface is configured for receiving task content inputted by a user. The task content may be in the form of a text or a non-text. When the task content is in the form of a text, the task content is the task requirement information. When the task content is in the form of a non-text, for example, the task content is a speech, a picture, or picture-text information, the task content may be converted into a text form, to obtain the task requirement information. The task generation interface may be displayed in the form of a web page. For example, the computer device may obtain task content inputted in a search box provided by the web page. The task generation interface may alternatively be a session interface provided by a social application. FIG. 3A is a schematic diagram of a task generation interface according to an embodiment of the present disclosure. In this embodiment, in a workflow scenario, the interactive task generation interface displays an interactive session. The interactive session is a session performed between a user account and a workflow customer service account. FIG. 3A displays speech information about a workflow generated when the interactive session is performed. The user may send the speech information by using the user account. In this embodiment of the present disclosure, the form of the information that the user may send in the interactive task generation interface by using the user account is not limited, and may be a speech, or may be text information, picture-text information, audio/video information, or the like, which is not specifically limited, provided that the information can be converted into corresponding task requirement information on which a large language model performs semantic interpretation. In an example, the task requirement information is a text, whose content is: At 6:00 p.m. every day, everyone in the group is reminded to write a daily work report. If the day is Friday, everyone in the group is reminded to write a weekly work report summary and a next-week work plan.

In one embodiment, the computer device may display the interactive task generation interface in response to a search operation on the workflow customer service account. The task content sent by using the user account may be displayed in the task generation interface. The computer device obtains the task requirement information according to the task content, and the computer device obtains the task requirement information inputted in the interactive task generation interface. In one embodiment, the user account may be an administrator account having task generation permission.

For example, in an instant messaging application logged into by using the user account, in response to a search operation on the workflow customer service account in a search box, the task generation interface, namely, the interactive task generation interface is displayed in the instant messaging application.

The computer device may display, in the task generation interface, a speech sent by using the user account, or a text sent by using the user account, or picture-text information sent by using the user account, or display, in the interactive task generation interface, an audio/video sent by using the user account. The speech may include a target speech signal. In a workflow scenario, the target speech signal is “workflow”, and the text or picture-text information may include a prompt word related to the target task. In a workflow scenario, the prompt word may be “production” or “target workflow”. In this embodiment of the present disclosure, neither content nor a format of the task requirement information is limited, and the user may input any content that can be understood by a natural language model.

If the input information is in a speech form, the computer device recognizes the speech information as a text, and uses the text as the task requirement information. If the interactive task generation interface displays a text, the computer device directly obtains the text. If the interactive task generation interface displays an audio/video, the computer device performs image recognition to obtain a related text, and uses the related text as the task requirement information. As shown in FIG. 3A, the figure is a diagram in a workflow scenario. Task requirement information is in a speech form. In response to an input operation on a speech, speech recognition progress prompt information such as “Speech recognition is in progress . . . ” is sent by using the workflow customer service account. After completing the speech recognition and obtaining the task requirement information, the computer device sends, by using the workflow customer service account, a speech recognition result such as “Speech recognition result: To help me make a workflow. At 6:00 p.m. every day, a member in the group can be reminded to write a daily work report. If the day is Friday, everyone is reminded to write a weekly work report summary and a next-week work plan”.

In some embodiments, the obtaining task requirement information inputted based on an interactive task generation interface includes: displaying the task generation interface in which human-machine information interaction is performed; receiving task content that is inputted by using the interactive task interface, and obtaining the task content; and performing semantic conversion on the task content, to obtain the task requirement information.

The human-machine information interaction refers to an information interaction process between a user and a machine. The semantic conversion is configured for recognizing semantics of task content and obtain a text matching the semantics.

In one embodiment, the computer device is provided with an interactive task generation interface in which human-machine information interaction can be performed. The interactive task generation interface may be an interface of a web page, or may be an interface of a program application, for example, an instant messaging application.

The computer device receives a task requirement speech sent by using the user account, obtains the task requirement speech, and displays the task requirement speech in the task generation interface. The computer device calls a trained semantic recognition model, and performs speech recognition on the workflow requirement speech by using the trained speech recognition model, to obtain a first recognition text. The computer device obtains the task requirement information according to the first recognition text.

For example, after determining the first recognition text, the computer device performs post-processing on the first recognition text to obtain the task requirement information. The post-processing includes punctuation addition and spelling correction.

A training operation of the trained speech recognition model includes: The computer device obtains a sample speech. The sample speech is obtained by using various types of speech receiving software and hardware. The computer device pre-processes the sample speech, to obtain a pre-processed sample speech. The pre-processing includes one or more types of processing of noise removal, speech segmentation, and speech feature extraction. The computer device performs feature extraction on the pre-processed sample speech, to obtain a corresponding target signal. The computer device sends the target signal to the to-be-trained speech recognition model for model training, to obtain the trained speech recognition model. The feature extraction is to convert the sample speech into a digital signal. The speech recognition model is a statistical model, and is configured for describing various features of a speech. The trained speech recognition model is configured for performing speech recognition on the target signal, that is, converting the digital signal into a text.

Alternatively, the computer device receives and obtains picture-text information sent by using the user account, displays the picture-text information on the task generation interface, performs picture-text recognition on the picture-text information by using a trained picture-text recognition model, to obtain a second recognition text, and determines the second recognition text as the task requirement information according to the second recognition text.

For example, after determining the second recognition text, the computer device performs post-processing on the second recognition text to obtain the task requirement information. The post-processing includes punctuation addition and spelling correction.

In this embodiment, the task content is inputted in the task generation interface, and semantic conversion is performed on the task content, to obtain task requirement information that can better reflect a task requirement, thereby better helping the large language model perform accurate semantic interpretation subsequently, to obtain a more accurate executable structural body of the target task.

Operation S204: Call a large language model, input the task requirement information into the large language model, and perform semantic interpretation on the task requirement information by using the large language model, to output an executable structural body of a target task matching the task requirement information.

The large language model is a natural language processing technology based on deep learning, and can predict and generate a text by training a large amount of corpus data. The large language model is generally a recurrent neural network (RNN) or its variant such as a long short term memory (LSTM) or a gated recurrent unit (GRU), to capture context information in a text sequence, thereby implementing tasks such as generation of a natural language text, language model evaluation, text classification, and sentiment analysis. In the field of natural language processing, large language models have been widely applied, for example, speech recognition, machine translation, automatic summarization, dialogue system, and intelligent question-answering. The large language model is configured for generating the target task matching the task requirement information. The semantic interpretation refers to interpretation or understanding semantics in the task requirement information, thereby performing related inference and judgment.

The executable structural body refers to a data structure that can execute the atomic task, for example, a DSL Json (a data structure of a data exchange format of a domain-specific language) structural body.

In one embodiment, the computer device performs semantic interpretation on the task requirement information by calling the large language model at least once, to obtain an executable structural body of a target task matching the task requirement information.

In some embodiments, the performing semantic interpretation on the task requirement information by using the large language model, to output an executable structural body of a target task matching the task requirement information includes: calling a prompt corpus constructed for a workflow by using the large language model, performing semantic interpretation on the task requirement information, to obtain the executable structural body of the target task matching the task requirement information, and outputting the executable structural body of the target task, the prompt corpus including prompt information constructed for each atomic task of the workflow, and the prompt information including an executable structural body and application information of the atomic task.

The atomic task is a task that can implement a basic function. For example, in a workflow scenario, the atomic task may be an application in a workflow platform, and each application may be understood as an atomic task. For example, as shown in Table 1, Table 1 lists applications supported by the workflow platform:

TABLE 1
Application list

| Classification | Application name |
|---|---|
| Trigger application | Event trigger |
| | Form trigger |
| | WebHook trigger |
| | Error trigger |
| | Manual trigger |
| | Instant messaging application trigger |
| | Synchronous API (application programming |
| | interface) trigger |
| Logic application | Delivery |
| | Approval |
| | Condition determination |
| | Condition filtering |
| | Assemble data |
| | Delayed wait |
| | Signal delivery |
| | Call a sub-workflow |
| Service application | Send a message |
| | Create a group |
| | Set a group |
| | Create a conference |
| | Modify a conference |
| | Cancel a conference |
| | Send an email |
| | Send an SMS message |
| | Send a speech message |
| | Script execution |
| | Database operation |
| | Initiate an API request |

Prompt information (that is, prompt) of each atomic task is configured for explaining an application scenario and a usage manner of the atomic task, and includes an executable structural body and application information of the atomic task, which may be configured for explaining how the atomic task is used, parameters involved in the usage, and what are input and output of the atomic task. Prompt information of each atomic task may include a question and an answer. For example, the following gives an example of content of respective prompt information of the atomic task [Initiate an API request] and the atomic task [Send an email]:

```
  prompt=[
    {“action”: “question”, “content”: “how to access an interface of a WEB
API?”},
    {“action”: “answer”, “content”: “it is implemented by using [Initiate an API
request] in a workflow, and ... needs to be configured”},
    {“action”: “question”, “content”: “how to send an email?”},
    {“action”: “answer”, “content”: “it is implemented by using [Send an email] in
a workflow, and ... needs to be configured”},
  ]
```

In the foregoing example, prompt refers to prompt information, and the WEB API is a web application programming interface. It can be seen from the foregoing example that, the prompt information of each atomic task includes a question and an answer, and the answer part includes a complete and detailed executable structural body. That is, the answer to the prompt information includes an executable structural body and application information of the atomic task. The application information includes script code, program code, a parameter, and the like. For example, if the atomic task is to execute a piece of programming language code, corresponding prompt information is shown in Table 2 below:

TABLE 2
List of prompt information

| Type | Content |
|---|---|
| Question | How to execute one piece of programming language code? |
| Answer | It is implemented by using the atomic task [execution of a programming language |
| | script] in a workflow, and application information includes: script code, a programming |
| | language version, a parameter, and the like. Executable structural body: |
| | { |
| | “id”: 222, |
| | “type”: “python”, |
| | “code”: “print(‘123’)”, |
| | “version”: “3.5”, |
| | “param”: “”, |
| | “preid”: 111, |
| | “nextid”: 333 |
| | } |

“id” in Table 2 indicates an id (identity) of an atomic task, and is configured for uniquely identifying the atomic task. The id field is randomly generated. “type” indicates a type field of the atomic task. “python” indicates that the atomic task is [Python script execution]. “code”: “print (‘123’)” refers to specifically executed code. “version”: “3.5” means that the version of the used programming language is version 3.5. “param” refers to an application parameter that needs to be configured for executing the programming language. “preid” refers to an id for executing a previous atomic task (a previous application). “nextid” refers to an id for executing a next atomic task. Based on this, it can be learned that prompt information of each atomic task not only includes a parameter and an executable structural body for executing the atomic task, but also indicates an atomic task previous to the executed atomic task and an atomic task next to the executed atomic task. That is, the entire workflow is concatenated by using preid and nextid to form sequential execution.

In one embodiment, the computer device obtains, from a corpus database, a prompt corpus for constructing a workflow, that is, obtains all prompt information configured for constructing the workflow, and prompt information of each atomic task is constructed in advance and stored. The computer device performs, according to the prompt corpus, semantic interpretation on the task requirement information by calling the large language model at least once, determines an executable structural body of a target task matching the task requirement information, and outputs the executable structural body of the target task.

A workflow scenario is used as an example for description. Before a large language model is called for the first time, prompt information about a call of the large language model is sent by using the workflow customer service account. As shown in FIG. 3A, the workflow customer service account sends prompt information about a call of a large language model: “Recognition by a large language model is in progress . . . ”, to remind the user that the large language model is being called currently. A target task matching the task requirement information is generated.

Each type of atomic task of the workflow platform requires corresponding prompt information, and each piece of prompt information is pre-written and may be configured for constructing different workflows. That is, for each piece of task requirement information, a pre-written prompt corpus may be directly obtained. Each atomic task has corresponding prompt information. In this way, when the executable structural body of the target task is generated, automatic generation of the executable structural body of the target task can be rapidly and accurately completed directly according to the prompt information of the corresponding atomic task.

In this embodiment, the calling a prompt corpus constructed for a workflow by using the large language model can perform accurate semantic interpretation on the task requirement information, to obtain the executable structural body of the target task matching the task requirement information.

In some embodiments, the calling a prompt corpus constructed for a workflow by using the large language model, and performing semantic interpretation on the task requirement information, to obtain the executable structural body of the target task matching the task requirement information includes: performing semantic interpretation according to the task requirement information and the prompt corpus by using the large language model, to obtain one or more target atomic tasks matching the task requirement information; and obtaining executable structural bodies of the one or more target atomic tasks from the prompt corpus, and obtaining, according to the executable structural bodies of the one or more target atomic tasks, the executable structural body of the target task matching the task requirement information.

For example, the computer device directly determines, according to the task requirement information and the prompt corpus, that the task requirement information is a target atomic task by calling the large language model once. In this case, the large language model directly obtains an executable structural body of the target atomic task, and directly uses the executable structural body of the target atomic task as an executable structural body of the target task. In this example, the inputted task requirement information is requirement information corresponding to an application. In this case, the executable structural body of the target task can be obtained by calling the large language model only once.

For example, a plurality of target atomic tasks matching the task requirement information are determined according to the task requirement information and the prompt corpus by calling the large language model at least once. The large language model is called again according to the plurality of target atomic tasks, the task requirement information, and the prompt corpus, to obtain executable structural bodies of the plurality of target atomic tasks. The computer device determines, according to the executable structural bodies of the plurality of target atomic tasks, an executable structural body of a target task matching the task requirement information, and outputs the executable structural body of the target task. In this example, the large language model is called at least twice, that is, a first call is performed to determine at least two target atomic tasks corresponding to the task requirement information, and a second call is performed to determine respective executable structural bodies of the target atomic tasks, thereby determining the executable structural body of the target task.

In this embodiment, the performing semantic interpretation according to the task requirement information and the prompt corpus by using the large language model can automatically obtain, through disassembly, one or more target atomic tasks matching the task requirement information, and the executable structural body of the target task matching the task requirement information can be directly obtained according to the executable structural bodies of the one or more target atomic tasks. In this way, task generation operations are simplified, and the user can automatically complete a task only by providing task requirement information without performing any complex operation, thereby improving task generation efficiency.

Operation S206: Perform graphic rendering on the target task based on the executable structural body of the target task, to obtain a task execution flowchart of the target task, and display the task execution flowchart in the task generation interface, the target task being formed according to one or more target atomic tasks.

The task execution flowchart is an image representation of the target task, and the task execution flowchart reflects an execution process of the target task.

In one embodiment, after the executable structural body of the target task is obtained, the computer device performs graphic rendering on the target task according to the executable structural body of the target task, to obtain a corresponding task execution flowchart, and displays the task execution flowchart of the target task in the interactive task generation interface.

For example, after the executable structural body of the target task is obtained, the computer device sends prompt information about graphic rendering of the workflow by using the workflow customer service account, the prompt information about graphic rendering of the workflow further including information indicating that a response of the large language model is completed. That is, once the prompt information about graphic rendering of the workflow is received, it indicates that the executable structural body of the target task is generated. In addition, the computer device is ready to perform a graphic rendering operation on the target task. As shown in FIG. 3A, after the executable structural body of the target task is obtained, the prompt information about graphic rendering of the workflow, for example, “A response of the large language model is completed, and graphic rendering of the workflow is in progress”, sent by using the workflow customer service account is displayed after the prompt information about a call of the large language model in the interactive task generation interface. In this way, once the executable structural body of the target task is determined, the user can clearly learn in time, through graphic rendering, that the current target task is automatically generated, and structural details of the target task can be clearly reflected by using the task execution flowchart. Meanwhile, the computer device obtains, through parsing, an execution process of the target task according to the executable structural body of the target task, and performs image rendering on the target task according to the execution process, to obtain the task execution flowchart of the target task.

In this case, after the rendering operation is completed, prompt information, such as “rendering completed” in FIG. 3A, about a rendering operation result is sent by using the workflow customer service account. Certainly, to ensure that the user can learn the task execution flowchart of the workflow in time, a bubble in which the prompt information about the rendering operation result is located may be dynamically displayed, or a text in a bubble in which the prompt information about the rendering operation result is located is flashed, or a color of a text in a bubble in which the prompt information about the rendering operation result is located is changed, which is not specifically limited.

For example, in the workflow scenario, after the prompt information about the rendering operation result is sent by using the workflow customer service account, a task execution flowchart of a target workflow (that is, a target task) is directly sent. In a task execution flowchart of a workflow, corresponding graphics for display are selected according to applications having different function types. For example, a graphic of an atomic task for triggering a workflow is redisplayed by using a circle. For example, a circle “Trigger at 18 o'clock” in FIG. 3A represents a manual trigger atomic task of a trigger function type. A graphic of an atomic task of a runnable function type is redisplayed by using a square. For example, squares “Learn what day is today”, “Remind of a weekly report”, and “Remind of a daily report” in FIG. 3A represent atomic tasks of the runnable function type. A graphic of an atomic task of a condition determination function type is redisplayed by using a rhombus. For example, a rhombus “Condition determination” in FIG. 3A is to determine whether today is Friday. If today is Friday, remind of a weekly report. If today is not Friday, remind of a daily report.

In this way, the displaying the task execution flowchart of the target task in the interactive task generation interface can more visually reflect a structure of the target task corresponding to the task requirement information. When an execution status of the target task is updated, the execution status of the target task is updated in real time in the task execution flowchart, to ensure that the user can learn a current execution progress in time, thereby improving user experience.

In some embodiments, after the displaying the task execution flowchart in the task generation interface, the method further includes: executing the target task; and updating, when an execution status of the target task is updated, the execution status of the target task in the task execution flowchart.

In one embodiment, the computer device executes the target task, and updates, in the task execution flowchart when verifying that the execution status of the target task changes from being non-executed to being executed, the execution status of the target task to an execution status of being executed.

For example, if the execution status of the target task changes from being non-executed to being executed, correspondingly, an execution identifier (ID) of being executed is displayed in the task execution flowchart. For example, when a color of the execution ID changes from a first color to a second color, the computer device determines that the execution ID is an execution ID of being executed, that is, an execution ID of the first color represents being non-executed, an execution ID of the second color represents being executed, and the first color and the second color are different. Alternatively, text information of being executed, for example, “Being executed” is displayed in the task execution flowchart. Alternatively, an execution ID is flashed in the task execution flowchart. If the execution ID is not flashed, it indicates being non-executed. If the execution ID is flashed, it indicates being executed.

When execution of the target task is completed, the computer device displays an execution ID of execution completed in the task execution flowchart. For example, text information of execution completed, such as “Execution completed” is displayed in the task execution flowchart. If execution of the target task is completed, the target task is in an execution ended status, which may be considered as a non-executed status. In this case, the execution ID of being non-executed may be displayed in the task execution flowchart, and correspondingly, the color of the execution ID is changed from the second color to the first color. For another example, when execution of the target task is completed, the computer device does not flash the execution ID in the task execution flowchart.

In this embodiment, once execution of the target task starts, the execution status of the target task needs to be updated. In this case, the execution status of the target task is updated in the task execution flowchart, so that the user can directly learn the execution status of the current target task, and may subsequently select, according to a requirement, whether to view an execution progress, thereby improving user experience.

Operation S208: Display an execution progress viewing link of the target task in the task generation interface, the execution progress viewing link being configured for viewing an execution progress of the target task.

For example, when execution of the target task starts, the execution progress viewing link of the target task is displayed in the interactive task generation interface. For example, FIG. 3B is a schematic diagram of an interactive task generation interface according to another embodiment. FIG. 3B shows a workflow scenario. When a target workflow starts to be executed, an execution progress viewing link, that is, a workflow address in FIG. 3B: http://autoflow.woa.com/workflow/playbook/manage/read/151458 is sent by using a workflow customer service account in the interactive task generation interface. In this case, a user may view an execution progress by clicking the execution progress viewing link.

In some embodiments, the method further includes: jumping to an execution progress viewing interface in response to a trigger operation on the execution progress viewing link; and displaying an execution progress of the target task in the execution progress viewing interface.

In one embodiment, when execution of the target task starts, the execution progress viewing link of the target task is displayed in the interactive task generation interface. The computer device jumps to an execution progress viewing interface in response to a trigger operation on the execution progress viewing link, and displays an execution progress of the target task in the execution progress viewing interface. Each time the computer device executes an atomic task of the target task, a task execution flowchart of the target task being executed is displayed in the execution progress viewing interface, and a sign of completed is displayed in a graphic corresponding to the completely executed atomic task.

FIG. 3C is a schematic diagram of an execution progress viewing interface according to an embodiment of the present disclosure. A sign of completed is shown in FIG. 3C. Currently completely executed atomic tasks are respectively a trigger atomic task “Trigger at 18 o'clock” and an executable atomic task “Learn what day is today”. Signs of completed are displayed in images corresponding to the two atomic tasks. For atomic tasks that are not executed, such as “Condition determination”, “Remind of a weekly report”, and “Remind of a daily report”, corresponding signs of completed are not displayed in the execution progress viewing interface.

In this embodiment, the execution progress viewing link of the target task is displayed in the interactive task generation interface; and the jumping to an execution progress viewing interface can be quickly performed in response to a trigger operation on the execution progress viewing link. In this way, the execution progress of the target task can be displayed in real time in the execution progress viewing interface, to ensure that the user can learn a current execution progress in time, thereby improving user experience.

In the foregoing task generation method based on a large language model, the task requirement information inputted based on the interactive task generation interface is obtained, the large language model is directly called, the task requirement information is inputted into the large language model, and semantic interpretation is performed on the task requirement information by using the large language model, to automatically obtain the executable structural body of the target task matching the task requirement information. Graphic rendering is performed on the target task based on the executable structural body of the target task, to obtain the task execution flowchart of the target task, and the task execution flowchart is displayed in the task generation interface, the target task being formed according to the one or more target atomic tasks, so that detailed information of the generated target task can be visually displayed. The execution progress viewing link of the target task is displayed in the task generation interface, the execution progress viewing link being configured for viewing an execution progress of the target task, to make it convenient to view the execution progress visually in time. That is, the user can complete automatic generation of a task only by providing the task requirement information without performing any complex operation, thereby simplifying task generation operations, and improving task generation efficiency.

In some embodiments, the calling a large language model includes: generating a call parameter according to the task requirement information and the prompt corpus; constructing a model call request according to the call parameter; and calling the large language model according to the model call request.

In one embodiment, if the large language model is called for the first time, the computer device combines the task requirement information and the prompt corpus, to obtain a call parameter of a first call, and constructs a model call request of the first call according to the call parameter of the first call. The computer device calls the large language model according to the model call request of the first call.

If the large language model is not called for the first time, the computer device obtains a previous output result outputted by a previous call, and combines the task requirement information, the prompt corpus, and the previous output result, to obtain a call parameter of a current call (not the first call). The computer device constructs a model call request of the current call according to the call parameter of the current call. The computer device calls the large language model according to the model call request of the current call.

If the large language model is not called for the first time, an output result outputted by a previous call is used as context information of a current call, and an executable structural body of the current call is determined with reference to the context information, thereby improving accuracy and reliability of generation of the target task.

The large language model provides a calling manner of a hyper text transfer protocol (HTTP) interface. Therefore, the model call request is an HTTP request, and the call parameter is directly written in a text part of the HTTP request, to construct the model call request. After the interpretation and prediction are performed by using the large language model, the executable structural body of the target task is returned to the computer device in a manner of an HTTP response packet.

If the computer device is a terminal, after obtaining the model call request, the terminal sends the model call request to a server, and calls the large language model according to the model call request by using the server.

In this embodiment, the call parameter is generated according to the task requirement information and the prompt corpus, so that the model call request configured for calling the large language model can be constructed according to the call parameter. The large language model is called according to the model call request, to obtain the one or more target atomic tasks that matches the task requirement information. Further, the executable structural body of the target task can be automatically obtained according to the executable structural bodies of the one or more target atomic tasks. Task generation operations are simplified, and the user can automatically complete a task only by providing task requirement information without performing any complex operation, thereby improving task generation efficiency.

In some embodiments, the performing semantic interpretation according to the task requirement information and the prompt corpus by using the large language model, to obtain one or more target atomic tasks matching the task requirement information includes: sequentially determining, according to the task requirement information and the prompt corpus by using the large language model, the one or more target atomic tasks matching the task requirement information.

Each atomic task has an atomic task ID uniquely corresponding to the atomic task.

In one embodiment, the computer device sequentially determines, according to the task requirement information and the prompt corpus, one or more target atomic tasks matching the task requirement information by calling the large language model at least once. When there is one target atomic task, the computer device automatically considers the one target atomic task as the number one in the execution sequence by default, determines an executable structural body of the target atomic task in the prompt corpus, and uses the executable structural body of the target atomic task as an executable structural body of the target task. If there is a plurality of target atomic tasks, the computer device determines an execution sequence of the target atomic tasks. Based on this, the computer device subsequently determines an executable structural body of the target task according to the execution sequence of the target atomic tasks, to render the target task, or may execute the target task according to the execution sequence of the target atomic tasks.

In this embodiment, the one or more target atomic tasks matching the task requirement information is sequentially determined according to the task requirement information and the prompt corpus by using the large language model. That is, a sequence of the one or more target atomic tasks required to implement the workflow requirement is determined. In this way, executable structural bodies of the one or more target atomic tasks may be subsequently combined according to next atomic task IDs indicated by respective executable structural bodies of the one or more target atomic tasks, to obtain the executable structural body of the target task matching the task requirement information. In this way, according to the large language model, problem analysis and flow design can be automatically performed on the task requirement information, and a sequence of executable structural bodies of the one or more target atomic tasks is determined without coding work, thereby greatly improving the efficiency of target task generation.

In some embodiments, the obtaining, according to the executable structural bodies of the one or more target atomic tasks, the executable structural body of the target task matching the task requirement information includes: combining executable structural bodies of the one or more target atomic tasks according to next atomic task IDs indicated by respective executable structural bodies of the one or more target atomic tasks, to obtain the executable structural body of the target task matching the task requirement information.

In one embodiment, for each target atomic task, the computer device determines, according to a next atomic task ID indicated by a structural body of the target atomic task, a next target atomic task whose execution sequence is after that of the target atomic task, and adds an executable structural body of the next target atomic task to the executable structural bodies that are currently combined, to obtain a currently combined executable structural body, until a combination of executable structural bodies of all the target atomic tasks is completed, to obtain a combined executable structural body. The combined executable structural body includes the executable structural bodies of all the target atomic tasks. The computer device uses the combined executable structural body as an executable structural body of the target task matching the task requirement information.

Using an example of an executable structural body of the atomic task shown in Table 2 above, the executable structural body of each atomic task includes a next atomic task ID (that is, nextid) of a next atomic task that is after the atomic task, and a previous atomic task ID (preid) of a previous atomic task that is after the atomic task. Therefore, for each target atomic task related to the target task, a next atomic task ID indicated by an executable structural body of the target atomic task may be understood as a next atomic task ID of a next target atomic task after the target atomic task. According to a next atomic task ID indicated by an executable structural body of each target atomic task, a next target atomic task located after an execution sequence of the target atomic task is selected from a plurality of atomic tasks related to the target task. Therefore, an execution sequence of the target atomic tasks can be learned.

For example, after determining m target atomic tasks matching the task requirement information, the computer device determines, according to a next atomic task ID indicated by an executable structural body of each target atomic task, an execution sequence of the target atomic tasks, and sequentially executes a target atomic task 1 to a target atomic task m according to the execution sequence, the target atomic task 1 being an atomic task executed first, and the target atomic task m being an atomic task executed last. Based on this, the computer device sequentially combines the executable structural body of the target atomic task 1, the executable structural body of the target atomic task 2, . . . , and the executable structural body of the target atomic task m, to obtain the executable structural body of the target task.

In this embodiment, the one or more target atomic tasks matching the task requirement information is sequentially determined according to the task requirement information and the prompt corpus by using the large language model. That is, a sequence of the one or more target atomic tasks required to implement the workflow requirement is determined. In addition, executable structural bodies of the one or more target atomic tasks are combined according to next atomic task IDs indicated by respective executable structural bodies of the one or more target atomic tasks, to obtain the executable structural body of the target task matching the task requirement information. In this way, according to the large language model, problem analysis and flow design can be automatically performed on the task requirement information, and a sequence of executable structural bodies of the one or more target atomic tasks is determined without coding work, thereby greatly improving the efficiency of task generation.

In some embodiments, the sequentially determining, according to the task requirement information and the prompt corpus by using the large language model, the one or more target atomic tasks matching the task requirement information includes: disassembling the task requirement information into a plurality of pieces of sub-requirement information by using the large language model; sequentially determining, for each piece of sub-requirement information according to the sub-requirement information and the prompt corpus, a target atomic task matching the sub-requirement information; and determining, according to the target atomic task matching each piece of sub-requirement information, the one or more target atomic tasks matching the task requirement information.

The task requirement information corresponds to an original task, and the original task is to generate a target task that corresponds to the task requirement information. The large language model may be called for a plurality of times. In this case, correspondingly, the task requirement information is disassembled into a plurality of levels. For example, first disassembly is performed on the task requirement information in the first call, to obtain second-level sub-requirement information. second disassembly is performed on each piece of second-level sub-requirement information in the second call, to obtain third-level sub-requirement information; . . . ; and x^{th} disassembly is performed on each piece of x^{th}-level sub-requirement information in the x^{th} call, to obtain (x+1)^{th}-level sub-requirement information, where 0≤x≤n; and x and n are both non-negative integers, and x is 0. The sub-requirement information includes level sub-requirement information corresponding to each disassembly. For example, the sub-requirement information includes second-level sub-requirement information, . . . , and (n+1)^{th}-level sub-requirement information. The (n+1)^{th}-level sub-requirement information obtained through the last disassembly may be considered as atomic requirement information. That is, the atomic requirement information is information corresponding to an atomic task. That is, each piece of atomic requirement information corresponds to an atomic task. The task requirement information can be disassembled into a combination of atomic requirement information of minimum information units by calling the large language model at least once.

In one embodiment, the computer device calls the large language model at least once, to disassemble the task requirement information into a plurality of pieces of sub-requirement information, where each piece of sub-requirement information has a corresponding execution sequence number. For each piece of sub-requirement information, a target atomic task corresponding to the sub-requirement information is determined according to the sub-requirement information and the prompt corpus, and an execution sequence of the target atomic task is determined according to an execution sequence number of the sub-requirement information. The computer device determines, according to the target atomic task matching each piece of sub-requirement information, the one or more target atomic tasks matching the task requirement information.

For example, the computer device calls the large language model n times, and disassembles the task requirement information into n+1 levels of sub-requirement information. Each level of sub-requirement information includes one or more pieces of sub-requirement information of the level. Starting from the (n+1)^{th}-level sub-requirement information, for each piece of (n+1)^{th}-level sub-requirement information, the computer device determines one or more target atomic tasks of an n^{th}-level sub-requirement information according to a target atomic task matching the (n+1)^{th}-level sub-requirement information. For each piece of n^{th}-level sub-requirement information, the computer device determines one or more target atomic tasks of an (n−1)^{th}-level sub-requirement information according to a target atomic task matching the n^{th}-level sub-requirement information. A target atomic task matching each piece of second-level sub-requirement information is obtained according to a similar processing process. The computer device determines, according to the target atomic task matching each piece of second-level sub-requirement information, the one or more target atomic tasks matching the task requirement information.

In this embodiment, the task requirement information is disassembled into a plurality of pieces of sub-requirement information by using the large language model. That is, the task requirement information is converted into requirement information of minimum information units. For each piece of sub-requirement information, a target atomic task matching the sub-requirement information is sequentially determined according to the sub-requirement information and the prompt corpus, and an original task corresponding to the task requirement information is subdivided into target atomic tasks of minimum task units. In this way, according to the target atomic task matching each piece of sub-requirement information, the one or more target atomic tasks matching the task requirement information is determined. Subsequently, the executable structural body of the target task can be automatically and accurately outputted based on this. Task generation operations are simplified, and the user can automatically complete a task only by providing task requirement information without performing any complex operation, thereby improving task generation efficiency.

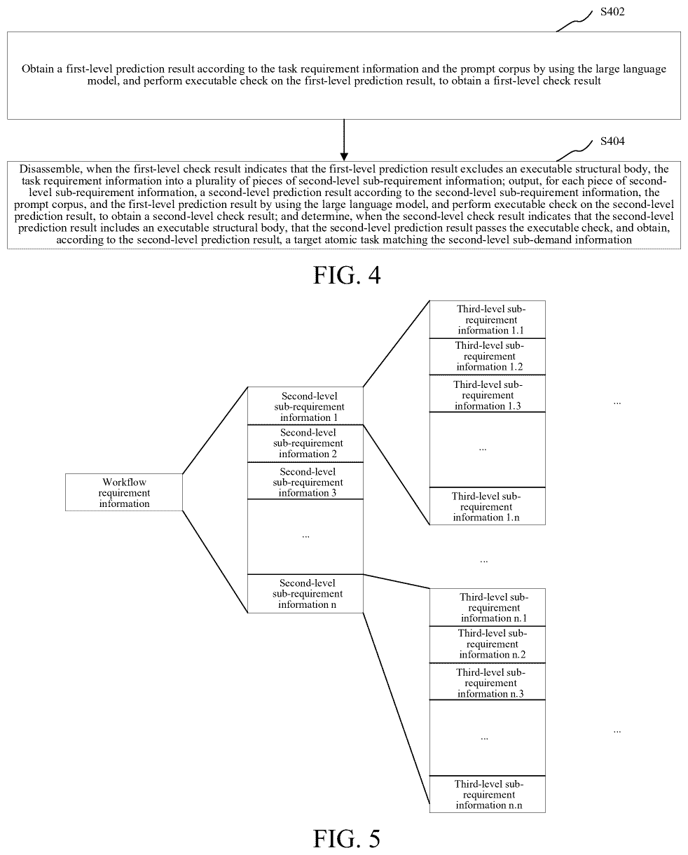

In some embodiments, FIG. 4 is a schematic flowchart of an operation of determining a target atomic task according to an embodiment of the present disclosure. The disassembling the task requirement information into a plurality of pieces of sub-requirement information by using the large language model; and sequentially determining, for each piece of sub-requirement information according to the sub-requirement information and the prompt corpus, a target atomic task matching the sub-requirement information includes:

Operation S402: Obtain a first-level prediction result according to the task requirement information and the prompt corpus by using the large language model, and perform executable check on the first-level prediction result, to obtain a first-level check result.

The first-level prediction result is a prediction result obtained by calling the large language model for the first time. The executable check is configured for checking whether the prediction result is an executable structural body. If executable check of an i^{th}-level prediction result is passed, the i^{th}-level prediction result includes an (i−1)^{th}-level prediction result located before the i^{th}-level prediction result. Because executable check of the (i−1)^{th}-level prediction result is not passed, the (i−1)^{th}-level prediction result includes a target atomic task matching atomic requirement information. In this case, the i^{th}-level prediction result further includes an executable structural body corresponding to the target atomic task matching the atomic requirement information. In conclusion, if the executable check of the i^{th}-level prediction result is passed, the i^{th}-level prediction result includes the target atomic task matching the atomic requirement information and the executable structural body corresponding to the target atomic task matching the atomic requirement information.

In one embodiment, the computer device calls the large language model for the first time, and outputs a first-level prediction result according to the task requirement information and the prompt corpus. When verifying that a format of the first-level prediction result is valid, the computer device performs executable check on the first-level prediction result, to obtain a first-level check result. The first-level check result represents a result obtained by performing executable check on the first-level prediction result.

For example, after the computer device obtains the first-level prediction result, the computer device performs format check on the first-level prediction result. If a corresponding format check result indicates that the format check is passed, the computer device returns to perform the operation of performing executable check on the first-level prediction result, to obtain a first-level check result. The format check is configured for checking whether a prediction result is a structural body. If a corresponding format check result represents that the format check is passed, it indicates that the first-level prediction result is a structural body, and a format of the structural body is valid. If the format check result represents that the format check is not passed, the first-level prediction result is not a structural body, or the first-level prediction result is an invalid structural body. In this case, the computer device does not need to perform executable check on the first-level prediction result, and the computer device directly disassembles the task requirement information, to disassemble the task requirement information into a plurality of pieces of second-level sub-requirement information.

Operation S404: Disassemble, when the first-level check result indicates that the first-level prediction result excludes an executable structural body, the task requirement information into a plurality of pieces of second-level sub-requirement information; output, for each piece of second-level sub-requirement information, a second-level prediction result according to the second-level sub-requirement information, the prompt corpus, and the first-level prediction result by using the large language model, and perform executable check on the second-level prediction result, to obtain a second-level check result; and determine, when the second-level check result indicates that the second-level prediction result includes an executable structural body, that the second-level prediction result passes the executable check, and obtain, according to the second-level prediction result, a target atomic task matching the second-level sub-requirement information.

In one embodiment, the computer device disassembles, when the first-level check result indicates that the first-level prediction result excludes an executable structural body, the task requirement information into a plurality of pieces of second-level sub-requirement information. The computer device calls the large language model for the second time, and inputs all of each piece of second-level sub-requirement information, the prompt corpus, and the first-level prediction result to the large language model. The computer device outputs, for each piece of second-level sub-requirement information, a second-level prediction result according to the second-level sub-requirement information, the prompt corpus, and the first-level prediction result by using the large language model. When verifying that a format of the second-level prediction result is valid, the computer device performs executable check on the second-level prediction result, to obtain a second-level check result. The second-level check result represents a result obtained by performing executable check on the second-level prediction result. When the second-level prediction result passes the executable check, the computer device obtains, according to the second-level prediction result, a target atomic task matching the second-level sub-requirement information.

For example, after the computer device obtains the second-level prediction result, the computer device performs format check on the second-level prediction result. If a corresponding format check result indicates that the format check is passed, the computer device returns to perform the operation of performing executable check on the second-level prediction result, to obtain a second-level check result. If a corresponding format check result represents that the format check is passed, it indicates that the second-level prediction result is a structural body, and a format of the structural body is valid. If a corresponding format check result represents that the format check is not passed, the second-level prediction result is not a structural body, or the second-level prediction result is an invalid structural body. In this case, the computer device does not need to perform executable check on the second-level prediction result, and the computer device directly disassembles the second-level sub-requirement information, to disassemble the task requirement information into a plurality of pieces of third-level sub-requirement information.

In this embodiment, a first-level prediction result is outputted according to the task requirement information and the prompt corpus by using the large language model, and executable check is performed on the first-level prediction result. That is, whether there is an executable structural body of the target atomic task in the first-level prediction result is checked. When the first-level check result indicates that the first-level prediction result excludes an executable structural body, it indicates that the large language model needs to be called twice. Before this, the task requirement information needs to be disassembled into a plurality of pieces of second-level sub-requirement information. For each piece of second-level sub-requirement information, a second-level prediction result is outputted according to the second-level sub-requirement information, the prompt corpus, and the first-level prediction result by using the large language model, and executable check is performed again on the second-level prediction result. When the second-level prediction result passes the executable check, a target atomic task matching the second-level sub-requirement information is obtained according to the second-level prediction result. In this way, an original task corresponding to the task requirement information can be subdivided into target atomic tasks of minimum task units, so that the executable structural body of the target task can be automatically and accurately outputted. Task generation operations are simplified, and the user can automatically complete a task only by providing task requirement information without performing any complex operation, thereby improving task generation efficiency.

In some embodiments, the method further includes: obtaining, when the first-level check result indicates that the first-level prediction result includes an executable structural body, a target atomic task matching the task requirement information according to the first-level prediction result.

When the first-level check result indicates that the first-level prediction result includes an executable structural body, it indicates that a task corresponding to the task requirement information is the target atomic task. In this case, as described above, if the first-level check result corresponding to the first-level prediction result indicates that the first-level prediction result passes the executable check, the first-level prediction result includes the target atomic task matching the atomic requirement information (the atomic requirement information is the task requirement information in this embodiment) and the executable structural body corresponding to the target atomic task matching the atomic requirement information.

In this embodiment, when the first-level check result indicates that the first-level prediction result includes an executable structural body, a target atomic task matching the task requirement information is directly obtained according to the first-level prediction result. That is, in this case, a task corresponding to the task requirement information is a target atomic task, so that it can be quickly and accurately determined that an executable structural body of the target atomic task is an executable structural body of the target task, complex encoding operations do not need to be performed, a flow of obtaining the executable structural body is simplified, and efficiency of target task generation is improved.

In some embodiments, the determining, according to the target atomic task matching each piece of sub-requirement information, the one or more target atomic tasks matching the task requirement information includes: obtaining target atomic tasks matching all the pieces of second-level sub-requirement information, and obtaining a disassembly sequence of the pieces of second-level sub-requirement information; and concatenating the target atomic tasks matching all the pieces of second-level sub-requirement information according to the disassembly sequence of the pieces of second-level sub-requirement information, to obtain the one or more target atomic tasks matching the task requirement information.

For each piece of second-level sub-requirement information, a concatenation sequence of a target atomic task matching the second-level sub-requirement information is a disassembly sequence of the second-level sub-requirement information.

In one embodiment, the computer device obtains target atomic tasks matching all the pieces of second-level sub-requirement information, and the computer device determines a concatenation sequence of respective target atomic tasks of the pieces of second-level sub-requirement information according to the disassembly sequence of the pieces of second-level sub-requirement information. The computer device sequentially concatenates, starting from a target atomic task of a first concatenation sequence, the respective target atomic tasks of the pieces of second-level sub-requirement information according to the concatenation sequence of respective target atomic tasks of the pieces of second-level sub-requirement information, to obtain one or more target atomic tasks matching the task requirement information.

For example, task requirement information P is disassembled into N pieces of second-level sub-requirement information, whose disassembly sequence is sequentially second-level sub-requirement information P2.1, second-level sub-requirement information P2.2, . . . , and second-level sub-requirement information P2.N. Therefore, a concatenation sequence of second-level sub-tasks corresponding to the pieces of second-level sub-requirement information is sequentially a second-level sub-task F2.1 corresponding to the second-level sub-requirement information P2.1, . . . , and a second-level sub-task F2.N corresponding to the second-level sub-requirement information P2.N. In this case, the one or more target atomic tasks matching the task requirement information is sequentially the second-level sub-task F2.1, . . . , and the second-level sub-task F2.N.

In this embodiment, the target atomic task matching each piece of second-level sub-requirement information is obtained. In this way, according to a disassembly sequence of pieces of second-level sub-requirement information, the target atomic task matching each piece of second-level sub-requirement information can be quickly concatenated according to a corresponding disassembly sequence, to obtain one or more target atomic tasks matching the task requirement information, and subsequently, an executable structural body of the target task can be automatically and accurately outputted. Task generation operations are simplified, and the user can automatically complete a task only by providing task requirement information without performing any complex operation, thereby improving task generation efficiency.

In some examples, the method further includes: disassembling, when the second-level prediction result corresponding to the second-level sub-requirement information does not pass the executable check, the second-level sub-requirement information into a plurality of pieces of third-level sub-requirement information; outputting, for each piece of third-level sub-requirement information, a third-level prediction result according to the third-level sub-requirement information, the prompt corpus, and the second-level prediction result corresponding to each piece of second-level sub-requirement information by using the large language model, and performing executable check on the third-level prediction result, to obtain a third-level check result; and determining, when the third-level check result indicates that the third-level prediction result includes an executable structural body, that the third-level prediction result passes the executable check, and obtaining, according to the third-level prediction result, a target atomic task matching the third-level sub-requirement information.

In one embodiment, the computer device disassembles, when the second-level prediction result corresponding to the second-level sub-requirement information does not pass the executable check, the second-level sub-requirement information into a plurality of pieces of third-level sub-requirement information For each piece of third-level sub-requirement information, the computer device calls the large language model again, and inputs all of each piece of third-level sub-requirement information, the prompt corpus, and a second-level prediction result corresponding to each piece of second-level sub-requirement information to the large language model. For each third-level sub-requirement information, the computer device outputs a third-level prediction result corresponding to the third-level sub-requirement information according to the third-level sub-requirement information, the prompt corpus, and the second-level prediction result corresponding to the second-level sub-requirement information by using the large language model. When verifying that a format of the third-level prediction result is valid, the computer device performs executable check on the third-level prediction result, to obtain a third-level check result. If the third-level check result indicates that the corresponding third-level prediction result passes the executable check, the computer device obtains, according to the third-level prediction result, a target atomic task matching the third-level sub-requirement information.

After the large language model is called each time, a prediction result generated in the call needs to be stored in a vector database as context information for a next call. For example, as mentioned above, the first-level prediction result generated in the first call is used as context information of the second-level prediction result generated in the second call, and the second-level prediction result generated in the second call is used as context information of the third-level prediction result generated in the third call. As described above, because each call of the large language model may generate a second-level sub-task (that is, a second-level task of a sub-task corresponding to level sub-requirement information corresponding to a previous call), a storage structure for calling and recording context is in a multi-level vector form. FIG. 5 is a schematic diagram of a multilevel vector storage structure according to an embodiment of the present disclosure. An original task is a task corresponding to the task requirement information. After the large language model is called for the first time, when the format of the first-level prediction result is invalid or the executable check fails, the task requirement information is disassembled into second-level sub-requirement information P2.1 to second-level sub-requirement information P2.N. After the large language model is called for the second time, when the format of the second-level prediction result is invalid or the executable check fails, each piece of second-level sub-requirement information is disassembled. For example, second-level sub-requirement information P2.1 is disassembled into third-level sub-requirement information P2.1.1 to third-level sub-requirement information P2.1.M. For another example, second-level sub-requirement information P2.N is disassembled into third-level sub-requirement information P2.N.1 to third-level sub-requirement information P2.N.K. By using the multilevel vector storage structure, a hierarchical analysis and disassembly process of a problem can be clearly described, and context information is called when the large language model is subsequently cyclically called, so that an executable structural body of a target task can be more accurately obtained.

Certainly, if the format of the third-level prediction result is invalid or the executable check is not passed, it indicates that the third-level sub-requirement information is not a minimum information unit yet, and the third-level sub-requirement information may continue to be further disassembled until both the format check of the i^{th}-level prediction result corresponding to the i^{th}-level sub-requirement information obtained through disassembly and the executable check are passed. In this case, the i^{th}-level sub-requirement information may be considered as a minimum information unit, that is, a corresponding task is a target atomic task matching the i^{th}-level sub-requirement information.

For example, when it is verified that the format of the third-level prediction result is invalid, the computer device directly determines that the third-level prediction result excludes an executable structural body. In this case, the computer device continues to disassemble the third-level sub-requirement information, to obtain one or more pieces of fourth-level sub-requirement information, and inputs all of the one or more pieces of fourth-level sub-requirement information, the prompt corpus, and the third-level prediction result corresponding to the third-level sub-requirement information to the large language model, to obtain a corresponding fourth-level prediction result. When it is verified that a format of the fourth-level prediction result is valid, executable check is performed on the fourth-level prediction result, to obtain a fourth-level check result. If the fourth-level check result indicates that the corresponding third-level prediction result passes the executable check, the computer device obtains, according to the fourth-level prediction result, a target atomic task matching the fourth-level sub-requirement information.

That is, a prediction result corresponding to current disassembly is determined based on corresponding sub-requirement information obtained through the current disassembly, the prompt corpus, and a check result obtained through previous disassembly by using the large language model. Once the prediction result corresponding to the current disassembly is valid and includes an executable structural body, a target atomic task of the sub-requirement information corresponding to the current disassembly is obtained from the prediction result corresponding to the current disassembly.

Once the prediction result corresponding to the current disassembly is invalid, or excludes an executable structural body, the corresponding sub-requirement information obtained through the current disassembly continues to be disassembled until a target atomic task is obtained. Referring to the foregoing embodiments, if the current disassembly is the first disassembly, the corresponding sub-requirement information obtained through the current disassembly is the second-level sub-requirement information, and a prediction result corresponding to the current disassembly is the second-level prediction result. If the current disassembly is the second disassembly, the corresponding sub-requirement information obtained through the current disassembly is the third-level sub-requirement information, and a prediction result corresponding to the current disassembly is the third-level prediction result. If the current disassembly is the third disassembly, the corresponding sub-requirement information obtained through the current disassembly is the fourth-level sub-requirement information, and a prediction result corresponding to the current disassembly is the fourth-level prediction result.

In this embodiment, when the second-level prediction result corresponding to the second-level sub-requirement information does not pass the executable check, it indicates that the large language model needs to be called three times. Before this, the second-level sub-requirement information needs to be disassembled into a plurality of pieces of third-level sub-requirement information, that is, the second-level sub-requirement information needs to be further subdivided. For each piece of third-level sub-requirement information, a third-level prediction result is outputted according to the third-level sub-requirement information, the prompt corpus, and the second-level prediction result corresponding to each piece of second-level sub-requirement information by using the large language model, and executable check is performed on the third-level prediction result. When the third-level prediction result passes executable check, it indicates that the third-level sub-requirement information has been subdivided into a minimum information unit. Based on this, the target atomic task matching the third-level sub-requirement information is obtained according to the third-level prediction result. That is, an original task corresponding to the task requirement information is subdivided into target atomic tasks of minimum task units, so that the executable structural body of the target task can be automatically and accurately outputted. Task generation operations are simplified, and the user can automatically generate a task only by providing task requirement information without performing any complex operation, thereby improving task generation efficiency.

In some embodiments, the determining, according to the target atomic task matching each piece of sub-requirement information, the one or more target atomic tasks matching the task requirement information includes: obtaining target atomic tasks matching all the pieces of third-level sub-requirement information, and obtaining a disassembly sequence of the pieces of third-level sub-requirement information and a disassembly sequence of the pieces of second-level sub-requirement information; concatenating the target atomic tasks matching all the pieces of third-level sub-requirement information according to the disassembly sequence of the pieces of third-level sub-requirement information, to obtain one or more target atomic tasks matching the second-level sub-requirement information; and concatenating the target atomic tasks matching all the pieces of second-level sub-requirement information according to the disassembly sequence of the pieces of second-level sub-requirement information, to obtain the one or more target atomic tasks matching the task requirement information.

For each piece of third-level sub-requirement information, a concatenation sequence of a target atomic task matching the third-level sub-requirement information is a disassembly sequence of the second-level sub-requirement information in the second disassembly. For each piece of second-level sub-requirement information, a concatenation sequence of a target atomic task matching the second-level sub-requirement information is a disassembly sequence of the second-level sub-requirement information in the third disassembly.

In one embodiment, the computer device determines a concatenation sequence of target atomic tasks matching the pieces of third-level sub-requirement information according to the disassembly sequence of the pieces of third-level sub-requirement information in the second disassembly. For each piece of second-level sub-requirement information, the computer device sequentially concatenates, starting from a first target atomic task of a first concatenation sequence, the respective target atomic tasks of the pieces of third-level sub-requirement information according to the concatenation sequence of respective target atomic tasks of the pieces of third-level sub-requirement information, to obtain one or more target atomic tasks of the second-level sub-requirement information. The computer device sequentially concatenates, starting from a first target atomic task of a second concatenation sequence, the respective target atomic tasks of the pieces of second-level sub-requirement information according to the concatenation sequence of respective target atomic tasks of the pieces of second-level sub-requirement information, to obtain one or more target atomic tasks matching the task requirement information. The first concatenation sequence is a concatenation sequence of a first one of the target atomic tasks matching the third-level sub-requirement information. The second concatenation sequence is a concatenation sequence of a first one of the target atomic tasks matching the second-level sub-requirement information.

For example, FIG. 5 is used as an example for description. The second-level sub-requirement information P2.1 corresponds to the third-level sub-requirement information P2.1.1 to the third-level sub-requirement information P2.1.M. The computer device performs concatenation according to a concatenation sequence of target atomic tasks matching the pieces of third-level sub-requirement information, that is, serially concatenates a sub-task 1.1, . . . , and a sub-task 1.n, to obtain target atomic tasks matching the second-level sub-requirement information P2.1, that is, the sub-task 1.1, . . . , and the sub-task 1.n (the sub-task 1.1, . . . , and the sub-task 1.n are respectively a target atomic task matching the third-level sub-requirement information P2.1.1, . . . , and a target atomic task matching the third-level sub-requirement information P2.1.M). Similarly, target atomic tasks of third-level sub-requirement information of another second-level sub-requirement information are concatenated, to obtain respective target atomic tasks matching the second-level sub-requirement information, for example, target atomic tasks matching the second-level sub-requirement information P2.N, that is, a sub-task n.1, . . . , and a sub-task n.n. The task requirement information corresponds to second-level sub-requirement information P2.1 to second-level sub-requirement information P2.N, and target atomic tasks matching the task requirement information are: a sub-task 1.1, . . . , a sub-task i.n, . . . , a sub-task n.1, . . . , and a sub-task n.n.

In this embodiment, the target atomic tasks that match all the pieces of third-level sub-requirement information concatenating according to the corresponding disassembly sequence, to obtain one or more target atomic tasks matching the second-level sub-requirement information corresponding to the pieces of third-level sub-requirement information. Based on this, by using a concatenation result of target atomic tasks of a plurality of pieces of third-level sub-requirement information corresponding to the same second-level sub-requirement information, one or more target atomic tasks of the second-level sub-requirement information located at a previous level is determined. The target atomic tasks matching all the pieces of second-level sub-requirement information are concatenated according to the corresponding disassembly sequence, to obtain the one or more target atomic tasks matching the task requirement information. That is, concatenation is performed level by level from the target atomic task corresponding to the minimum information unit, to finally obtain all sequentially concatenated target atomic tasks. In this way, subsequently, each target atomic task may be sequentially executed according to a concatenation sequence of the target atomic tasks, to automatically execute the target task.

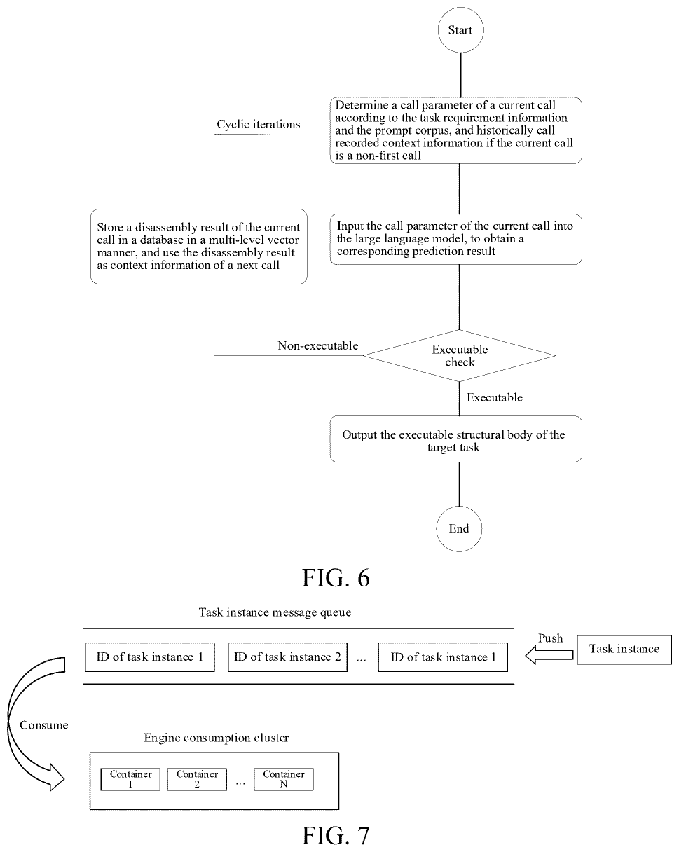

In some embodiments, FIG. 6 is a schematic flowchart of generating an executable structural body of a target task according to an embodiment of the present disclosure. After task requirement information and a prompt corpus are obtained, if a large language model is called for the first time, a call parameter is generated according to the task requirement information and the prompt corpus, the call parameter is inputted into the large language model, to obtain a first-level prediction result, and executable check is performed on the first-level prediction result. When a first-level check result indicates that the first-level prediction result excludes an executable structural body, that is, cannot be executed, or a format of the first-level prediction result is invalid, the task requirement information is disassembled into a plurality of pieces of second-level sub-requirement information, and the pieces of second-level sub-requirement information are used as context information for calling the large language model for the second time, and stored in a database in a manner of a multilevel vector. If it is verified that a format of the first-level prediction result is valid, and the first-level check result indicates that the first-level prediction result includes an executable structural body, a result is outputted, that is, an executable structural body of a target task is outputted.

If the current call is not the first call of the large language model, the computer device obtains context information of the current call (for example, if the current call is the second call, the context information of the current call is the second-level sub-requirement information; or if the current call is the third call, the context information of the current call is the third-level sub-requirement information), uses the context information of the current call, the prompt corpus, and a level prediction result corresponding to a previous call as a call parameter of the current call (if the current call is the second call, the level prediction result corresponding to the previous call is the first-level prediction result; or if the current call is the third call, the level prediction result corresponding to the previous call is the second-level prediction result), and inputs the call parameter of the current call to the large language model, to obtain the level prediction result of the current call (if the current call is the second call, the level prediction result of the current call is the second-level prediction result; or if the current call is the third call, the level prediction result of the current call is the third-level prediction result; and so on). If neither the format check nor the executable check performed on the level prediction result of the current call is passed, the context information of the current call is disassembled, to obtain a disassembly result of the current call. The disassembly result of the current call (for example, if the current call is the second call, the disassembly result of the current call is third-level sub-requirement information) is stored in the database in a manner of a multilevel vector, and used as context information of a next call. Cyclic iterations are performed until an executable structural body is obtained.

In this embodiment, by obtaining the task requirement information inputted in a task generation interface, namely, an interactive task generation interface, the user may directly input workflow requirement information to the task generation interface, namely, the interactive task generation interface. A prompt corpus constructed for a workflow is obtained, the prompt corpus including prompt information constructed for each atomic task of the workflow, and the prompt information including an executable structural body and application information of the atomic task. The performing semantic interpretation according to the task requirement information and the prompt corpus by using the large language model can automatically and accurately obtain one or more target atomic tasks matching the task requirement information, and automatically and accurately output the executable structural body of the target task matching the task requirement information according to the executable structural bodies of the one or more target atomic tasks. In this way, task generation operations are simplified, and the user can automatically complete a task only by providing task requirement information without performing any complex operation, thereby improving task generation efficiency.

In some embodiments, the method further includes: creating a task instance about the target task when an execution instruction for executing the target task is triggered, the task instance including one or more sub-task instances, and the sub-task instance being configured for executing a corresponding target atomic task; and sequentially executing, from a first sub-task instance of the task instance, the one or more sub-task instances according to executable structural bodies of the one or more sub-task instances.

The target task corresponds to one task instance, and the task instance refers to a specific target task instance. The task instance includes one or more sub-task instances respectively corresponding to one or more target atomic tasks. Each target atomic task uniquely corresponds to one sub-task instance. One target atomic task may be executed by using different parameters. Therefore, a sub-task instance may be understood as a process of executing the target atomic task by using a specific parameter. An executable structural body of a sub-task instance is an executable structural body of a corresponding target atomic task. That is, an actual running process of the target atomic task is performed based on a specific parameter used by the corresponding sub-task instance and with reference to a corresponding executable structural body.

In one embodiment, after obtaining the executable structural body of the target task, the computer device may directly trigger an execution instruction for executing the target task, and the computer device creates a task instance about the target task. The task instance includes one or more sub-task instances corresponding to one or more target atomic tasks required for generating the target task.

In one embodiment, after obtaining the executable structural body of the target task, the computer device may store the executable structural body of the target task, and trigger execution of the target task after waiting for a preset period of time, and the computer device creates a task instance about the target task.

In one embodiment, after obtaining the executable structural body of the target task, the computer device triggers, in response to a trigger operation on the target task, an execution instruction for executing the target task, and the computer device creates a task instance about the target task.

After creating the task instance about the target task, the computer device executes, starting from the first sub-task instance of the task instance, the sub-task instance according to an executable structural body of the sub-task instance, to complete a target atomic task corresponding to the sub-task instance.

In this embodiment, a task instance about the target task is first created when an execution instruction for executing the target task is triggered. Based on this, a sub-task instance of a corresponding target atomic task can be determined. Therefore, from a first sub-task instance of the task instance, the one or more sub-task instances are sequentially executed according to executable structural bodies of the one or more sub-task instances, so that the target task can be sequentially executed, thereby ensuring accuracy of execution of the target task.

In some embodiments, after the creating a task instance about the target task, the method further includes: creating a task instance corresponding to the target task in a task instance table of a database, the task instance table being configured for recording a task instance ID and a flow data structure of the task instance, and the flow data structure including a sub-task instance ID and a pointing relationship between the one or more sub-task instances; pushing the task instance ID of the created task instance to a task instance message queue; and performing, after the task instance ID is consumed from the task instance message queue, the operation of sequentially executing, from a first sub-task instance of the task instance, the one or more sub-task instances according to executable structural bodies of the one or more sub-task instances.

The flow data structure of the task instance may be understood as the executable structural body of the target task. The task instance corresponding to the target task created in the task instance (execution) table of the database records relevant information of the task instance, including a task instance ID and the flow data structure of the task instance as well as a target task ID, a running status of the task instance, a start time and an end time of execution of the task instance, an executor triggering execution of the task instance, and the like. The flow data structure of the task instance records an execution flow of the task instance, that is, the pointing relationship between the sub-task instances. The computer device sequentially loads and executes the sub-task instances, which means performing traversal and execution according to the pointing relationship between the sub-task instances included in the flow data structure. Each sub-task instance corresponds to one target atomic task. The execution relationship of the sub-task instance 2 reflects a sub-task instance preceding the sub-task instance 2, and reflects a sub-task instance following the sub-task instance 2.

For example, each task instance in the task instance table includes the following fields:
id: Task instance ID;
workflow_id: Workflow ID;
name: Name;
executor: Executor;
status: Running status of the task instance;
start_at: Start time;
end_at: End time;
apps: Executable structural body of the task instance;
where the executable structural body of the task instance may include the following information:
StartAppInstId: Start sub-task instance;
DestAppInstId: Destination sub-task instance;
Apps: Sub-task instance array, where each sub-task instance includes the following information:
Name: Name or description of a sub-task instance description;
Parameters: Parameters of the sub-task instance, including a parameter, a parameter value, a parameter type, and a parameter description;
Template: Sub-task template used by the sub-task instance, for example, an HTTP request or a Python script;
Position: Coordinate position of the sub-task instance in a front-end canvas;
InstId: ID of the sub-task instance;
PrevAppInstIds: ID of a pointed-to previous sub-task instance;
NextAppInstIds: ID of a pointed-to next sub-task instance;
Output: Output result of the sub-task instance;
Error: Error information indicating that the sub-task instance has an error in execution;
Status: Running status of the sub-task instance;
StartTime: Start time of execution of the sub-task instance;
EndTime: End time of execution of the sub-task instance.

As can be seen, a task instance includes a plurality of sub-task instances, and each sub-task instance has a unique ID to locate a specific sub-task instance in the task instance.

In one embodiment, the computer device creates, when receiving an execution instruction that triggers a target task, a corresponding task instance, including relevant information such as a task instance ID, an executor of the task instance, a flow data result of the task instance, and a status of the task instance, and persistently stores the created task instance in the task instance table in the database. Then, the computer device further pushes a task instance ID corresponding to the task instance to a task instance message queue (for example, a message format in the queue is: RPUSH execution #queue executionId. A distributed execution node consumes a sub-task instance ID from the task instance message queue, reads the task instance table in the database according to the consumed task instance ID, obtains a task instance corresponding to the sub-task instance ID, and starts to execute the task instance after reading relevant information of the task instance.

FIG. 7 is a schematic diagram of a task instance message queue according to an embodiment of the present disclosure. FIG. 7 shows a workflow scenario. Each time execution of a workflow is triggered, a corresponding task instance is created in a task instance table of a database, and a task instance ID corresponding to the created task instance is pushed to a task instance message queue. A computer device monitors the task instance message queue. In one embodiment, the task instance message queue is monitored according to containers (which may be understood as distributed execution nodes, as shown in the figure, a container 1, a container 2, . . . , and a container N) in an engine consumption cluster of a distributed workflow engine deployed in the computing device. Once new task instance IDs exist in the message queue, the new task instance IDs are sequentially consumed in a first-in-first-out sequence, and corresponding task instances are executed.

When a task instance of a target task is consumed, one or more sub-task instances are sequentially executed according to executable structural bodies of the one or more sub-task instances from a first sub-task instance of the task instance.

In this embodiment, a task instance corresponding to the target task is created in a task instance table of a database. The task instance ID of the created task instance is pushed to a task instance message queue, to wait for consumption. After a task instance ID is consumed from the task instance message queue, it indicates that the current to-be-executed task is the target task. Therefore, from a first sub-task instance of the task instance, the one or more sub-task instances are sequentially executed according to executable structural bodies of the one or more sub-task instances, so that the target task can be sequentially executed, thereby ensuring accuracy of execution of the target task.

In some embodiments, the sequentially executing, from a first sub-task instance of the task instance, the one or more sub-task instances according to executable structural bodies of the one or more sub-task instances includes: pushes a sub-task instance ID corresponding to the first sub-task instance to a sub-task instance message queue; consuming a sub-task instance ID from the sub-task instance message queue; loading a corresponding sub-task instance according to the sub-task instance ID, and executing the corresponding sub-task instance; determining, after the corresponding sub-task instance is executed, a sub-task instance to which the corresponding sub-task instance points; and returning, after a sub-task instance ID corresponding to the pointed-to sub-task instance is pushed to the sub-task instance message queue, to continue performing the operation of consuming a sub-task instance ID from the sub-task instance message queue, until all the one or more sub-task instances of the task instance are executed completely.

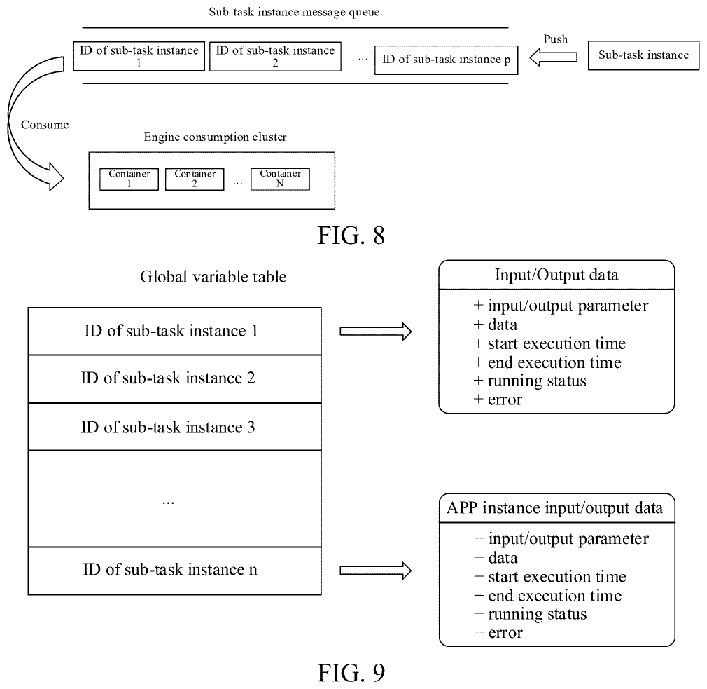

For example, FIG. 8 is a schematic diagram of a sub-task instance message queue according to an embodiment of the present disclosure. In FIG. 8, descriptions are provided by using an example in which a task instance includes p sub-task instances. Starting from a first sub-task instance of the task instance, a computer device pushes a corresponding sub-task instance ID 1 to the sub-task instance message queue, and obtains a sub-task instance table of the corresponding sub-task instance ID 1. After the sub-task instance ID is consumed by a container, the computer device loads the corresponding sub-task instance to an internal memory for execution, updates a running status and execution data of the sub-task instance after the execution ends, stores the sub-task instance to the corresponding sub-task instance table in a database, and obtains a pointed-to next sub-task instance. Similarly, the computer device pushes a corresponding sub-task instance ID 2 to the sub-task instance message queue. After the sub-task instance ID is consumed by a container, the computer device loads the corresponding sub-task instance to the internal memory for execution, and obtains a pointed-to next sub-task instance after the execution ends. Similarly, the computer device pushes a corresponding sub-task instance ID p to the sub-task instance message queue. After the sub-task instance ID is consumed by a container, the computer device loads the sub-task instance to the internal memory for execution. After the execution ends, the entire task instance is executed completely. During execution, each container runs a daemon to monitor the sub-task instance message queue, that is, a command: BLPOP appinst #queue. Once new sub-task instance IDs exist in the message queue, the new sub-task instance IDs are sequentially consumed in a first-in-first-out sequence, and corresponding task instances are executed. A container that first consumes a new sub-task instance ID executes a new sub-task instance.

In this embodiment, a plurality of sub-task instances corresponding to a task instance corresponding to a target task are sequentially loaded and executed. When the plurality of sub-task instances includes a time-consuming sub-task that needs to interact with the outside, the entire task instance does not need to be loaded at a time to wait for execution of the time-consuming sub-task and the entire task instance does not need to occupy the internal memory and consume running resources for a long time, which can greatly improve the resource utilization efficiency.

After consuming and obtaining a to-be-processed sub-task instance from the sub-task instance message queue, the computer device updates a data status corresponding to the sub-task instance in the database to being processed, and sets an execution start time. The sub-task instance is stored by using a corresponding sub-task instance table. Fields of each sub-task instance table are as follows:
id: Auto-increment primary key ID, namely, an application ID of a workflow system;
execution id: ID of execution of a task instance;
app_inst_id: ID of a sub-task instance;
name App: Name of a sub-task instance;
template App: Used template type (such as an HTTP request or a python script), where different sub-task instance templates support different functions;
status: Running status of the sub-task instance;
start_at: Start time of execution of the sub-task instance;
end_at: End time of execution of the sub-task instance.
apps: Executable structural body of a sub-task instance, which records information such as an execution result of the current sub-task instance at a time, a previous sub-task instance to which the current sub-task instance points, a next sub-task instance to which the current sub-task instance points, input parameters, and runtime data. The apps field is described above, and details are not described herein again.

In some examples, the pushing a sub-task instance ID corresponding to the pointed-to sub-task instance to the sub-task instance message queue includes: pushing, when the corresponding sub-task instance points to a plurality of sub-task instances, each of respective sub-task instance IDs of the plurality of pointed-to sub-task instances to the sub-task instance message queue.

The current sub-task instance points to a plurality of sub-task instances, and generally, the plurality of sub-task instances is independent of each other, and may be concurrently executed. In this case, the computer device may push each of respective sub-task instance IDs of the plurality of pointed-to sub-task instances to the sub-task instance message queue.

In this embodiment, pushing, when the corresponding sub-task instance points to a plurality of sub-task instances, each of respective sub-task instance IDs of the plurality of pointed-to sub-task instances to the sub-task instance message queue. In this way, it can be ensured based on the sub-task instance message queue that each pointed-to sub-task instance is executed subsequently, thereby ensuring accuracy and effectiveness of task execution.

In some embodiments, the consuming a sub-task instance ID from the sub-task instance message queue includes: concurrently loading and executing the plurality of corresponding sub-task instances after the plurality of sub-task instance IDs are consumed from the sub-task instance message queue by using distributed execution nodes.

The distributed execution nodes concurrently load and execute the plurality of sub-task instances after respectively consuming the plurality of sub-task instance IDs from the message queue. For example, if the sub-task instance A points to the sub-task instances B and C and the sub-task instances B and C are executed independently of each other, the computer device may push the two sub-task instances to the sub-task instance message queue, the distributed execution node 1 consumes an ID of the sub-task instance B from the message queue, the execution node 2 consumes an ID of the sub-task instance C from the message queue, and the two sub-task instances are concurrently executed on different execution nodes to achieve true concurrent loading and execution.

In this embodiment, compared with a case that an execution node loads an entire task instance to an internal memory for execution at a time, sub-task instances can only be sequentially executed according to a pointing relationship between sub-task instances of the task instance, the same node apparently can execute only one sub-task instance at a time, and real concurrency cannot be implemented, in this embodiment, because a plurality of sub-task instances of a task instance is separated and sequentially loaded and executed, when a sub-task instance points to a plurality of sub-task instances, the sub-task instances may be respectively loaded and executed by different distributed execution nodes, thereby implementing real concurrent execution.

In an embodiment, after determining the sub-task instance to which the current sub-task instance points, the computer device persistently stores the pointed-to sub-task instance to a sub-task instance table of a database, the sub-task instance table being configured for recording sub-task instance IDs, and running statuses and execution data of sub-task instances; initializes a running status of the sub-task instance to unprocessed; and updates the running status of the sub-task instance to completed in the sub-task instance table after the sub-task instance is executed, and updates the execution data of the sub-task instance.

In this embodiment, once a sub-task instance is executed, a running status of the sub-task instance is directly updated in the sub-task instance table, and execution data of the sub-task instance, for example, data outputted by executing the sub-task instance is updated in real time.

In an embodiment, the workflow processing method further includes: parsing the task instance, obtaining global variables of the included sub-task instances, and forming and storing a global variable table; the global variables including global input variables and global output variables; updating the global output variables in the global variable table according to corresponding execution data after the current sub-task instance is executed; and loading the updated global variable table, obtaining input data corresponding to the global input variable of the sub-task instance pointed to, and executing, according to the input data, the sub-task instance pointed to.

In the process of sequentially loading sub-task instances of an execution instance of the target task, if input data of one sub-task instance exists is output data of a previous sub-task instance before the sub-task instance, for example, output data of the previous sub-task instance that may be a previous sub-task instance to which the sub-task instance points, or for another example, output data of the previous sub-task instance that may be two previous sub-task instances to which the sub-task instance points, the output data of each sub-task instance cannot be directly transmitted because a plurality of sub-task instances of a task instance is separated and sequentially loaded and executed.

Therefore, to smoothly execute each loaded sub-task instance, the computer device may parse global variables of sub-task instances of a task instance to form a global variable table and store the global variable table, that is, an ID of each sub-task instance and a corresponding global variable (including a global input variable and a global output variable) are correspondingly stored. When the task instance is not executed, each variable in the global variables is a default parameter value. Each time a sub-task instance is loaded and executed and execution data is obtained, the global variable table is updated according to the execution data. Before each execution of the sub-task instance pointed to, a previously updated global variable table is loaded into the internal memory. According to the ID of the sub-task instance pointed to, the global variable table is read, and input data corresponding to the global input variable of the sub-task instance is read. Next, the sub-task instance may be executed according to the input data.

FIG. 9 is a schematic diagram of a global variable table according to an embodiment of the present disclosure. As shown in FIG. 9, global variables of sub-task instances of a currently processed task instance are loaded into an internal memory to form a mapping table between sub-task instance IDs and the global variables.

For example, the global variable of each sub-task instance may be a constant. For example, the global variable of each sub-task instance may make reference to output data of any previous sub-task instance by using a path syntax expression. When a sub-task instance pointed to needs to be executed, the computer device locates the corresponding global variable in the global variable table through the ID of the sub-task instance. In the case of a path syntax expression, the path syntax expression is parsed into corresponding data according to data corresponding to global variables included in the path syntax expression in the global variable table, to obtain input data of the sub-task instance pointed to.

For example, a data structure of a sub-task instance includes a parameter field, whose structure is as follows:
<parameter key, parameter value, parameter type, parameter description>

Parameter types include: string, boolean, number, and the like. The parameter value may either be a constant (number or string), or make reference to an output result of any previous sub-task instance by using the path syntax expression. An example is as follows:

<sub-task instance Id>.data;
<sub-task instance Id>.parameter.<parameter key value>;

In this embodiment, according to sub-task instance IDs, input data and output data of corresponding sub-task instances can be located, and execution data of each sub-task instance may be stored in the database, so that the execution data of the sub-task instances can be loaded into the internal memory and the global variable table can be updated, to parse out data corresponding to the path syntax expression used in input parameters of the sub-task instances. In this way, once input data of a sub-task instance is output data of a previous sub-task instance before the sub-task instance, the output data of the corresponding previous sub-task instance can be quickly read by using the global variable table stored in the local internal memory, thereby improving a data reading speed.

In some embodiments, the method further includes: obtaining a training corpus related to a workflow, the training corpus including a plurality of workflow sample texts and a label corresponding to each of the workflow sample texts; performing semantic interpretation according to the training corpus by using a to-be-trained semantic interpretation model, to obtain a prediction result corresponding to each workflow sample text; and performing model training on the to-be-trained semantic interpretation model according to the prediction result and the label that correspond to each workflow sample text, to obtain a trained semantic interpretation model, and using the trained semantic interpretation model as a large language model.

In one embodiment, the computer device obtains the training corpus related to the workflow. The training corpus is a technical corpus related to a workflow engine and a running instance. The computer device further obtains a common natural corpus. The natural corpus includes related natural sample texts such as a web page, news, and a novel. The computer device separately performs data pre-processing on the training corpus and the natural corpus, for example, performs processing such as cleaning, word segmentation, and stop word removal on workflow sample texts and natural sample texts, to obtain processed workflow sample texts and processed natural sample texts. The computer device performs statistics and calculation on words appearing in all the processed workflow sample texts and the processed natural sample texts, to establish a dictionary, and each word in the dictionary has a unique corresponding serial number. The computer device separately inputs the processed workflow sample texts and the processed natural sample texts into the to-be-trained semantic interpretation model for training, to obtain a prediction result corresponding to each processed workflow sample text and a prediction result corresponding to each processed natural sample text. The computer device determines a target loss according to the prediction result and the label that correspond to each processed workflow sample text and the prediction result and the label that correspond to each processed natural sample text, adjusts a model parameter of the to-be-trained semantic interpretation model to obtain a trained semantic interpretation model with a target of minimizing the target loss, and uses the trained semantic interpretation model as a large language model. The to-be-trained semantic example model is constructed by using a neural network model.

Certainly, in a training process, the computer device may further enrich, through dropout and batch normalization, training texts configured for model training, thereby improving a model training effect.

In this embodiment, a semantic interpretation capability of the to-be-trained semantic interpretation model is trained by using abundant and rich training corpora related to the workflow and a large quantity of computing resources, to ensure that the trained semantic interpretation model is applicable to fields such as natural language generation, machine translation, and speech recognition. In this way, the trained semantic interpretation model is used as a large language model, so that atomic fine-grained decomposition can be accurately performed on the task requirement information, to obtain a target atomic task, and an executable structural body of the target task that matches the task requirement information can be accurately generated, thereby automatically executing the target task.

The present disclosure further provides an application scenario. The foregoing task generation method based on a large language model is applied to the present disclosure scenario. In one embodiment, the application in which the task generation method based on a large language model is applied to the present disclosure scenario is described, for example, as follows: In a scenario of an instant messaging application, to facilitate management of a service project by a manager, a target task needs to be generated, that is, a target workflow related to the service project needs to be generated. The manager may automatically generate, according to task requirement information corresponding to the service project, an executable structural body of the target task related to the service project by using the task generation method based on a large language model provided in the embodiments of the present disclosure. In this way, the service project may be managed by using the executable structural body of the target task. In one embodiment, task requirement information inputted based on an interactive task generation interface is obtained; a large language model is called, the task requirement information is inputted into the large language model, and semantic interpretation is performed on the task requirement information by using the large language model, to output an executable structural body of a target task matching the task requirement information; graphic rendering is performed on the target task based on the executable structural body of the target task, to obtain a task execution flowchart of the target task, and display the task execution flowchart in the task generation interface, the target task being formed according to one or more target atomic tasks; and an execution progress viewing link of the target task is displayed in the task generation interface, the execution progress viewing link being configured for viewing an execution progress of the target task. In this way, a matching executable structural body can be automatically generated without manually performing additional programming on the target task, thereby improving efficiency of generating the target task.

Certainly, the present disclosure is not limited thereto. The task generation method based on a large language model provided in the present disclosure may be further applied to another application scenario. For example, an executable structural body of a target task is pre-generated by using the task generation method based on a large language model provided in the embodiments of the present disclosure, and is pre-stored in a database. If a development technician needs to develop a product, normal running of the product relates to normal execution of the target task. Based on this, the executable structural body of the target task may be directly called for application. The target task is generated without spending additional time on encoding, thereby improving encoding efficiency.

The above application scenarios are only exemplary illustrations. The application of the task generation method based on a large language model provided by the embodiments of the present disclosure is not limited to the above scenarios.

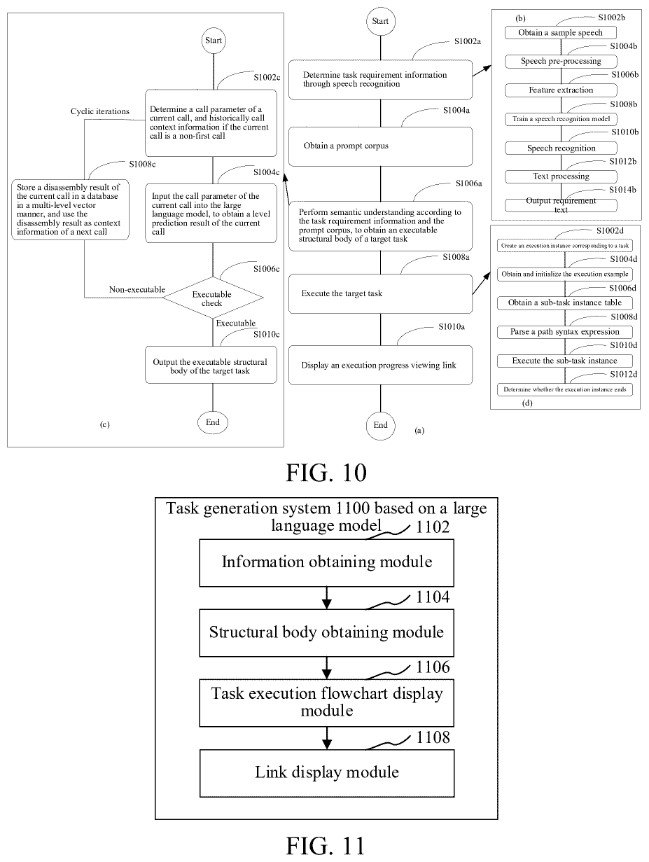

In a specific embodiment, a task generation method based on a large language model is provided. The method is performed by a computer device. FIG. 10 is a schematic flowchart of workflow execution according to an embodiment of the present disclosure. (a) in FIG. 10 is operation S1002a to operation S1010a.

Operation S1002a: Determine task requirement information through speech recognition.

In one embodiment, a computer device may obtain task requirement speech, text, or picture-text information inputted in an interactive task generation interface; and performs semantic conversion processing on the task requirement speech, text, or picture-text information, to obtain task requirement information.

Conversion of the task requirement speech into the task requirement information is used as an example below for description.

For a specific process of operation S1002a, refer to (b), that is, operation S1002b to operation S1014b:

Operation S1002b: Obtain a sample speech.

The sample speech is obtained by using various types of speech receiving software and hardware.

Operation S1004b: Speech pre-processing.

In one embodiment, the computer device performs speech pre-processing on the sample speech, to obtain a pre-processed sample speech. The pre-processing includes one or more types of processing of noise removal, speech segmentation, and speech feature extraction.

Operation S1006b: Feature extraction.

In one embodiment, the computer device performs feature extraction on the pre-processed sample speech, to obtain a corresponding target signal.

Operation S1008b: Train a speech recognition model.

In one embodiment, a target signal is sent to a to-be-trained speech recognition model for model training, to obtain a trained speech recognition model.

After the computer device obtains a workflow requirement speech sent by using a user account in the interactive task generation interface, operation S1010b is performed.

Operation S1010b: Speech recognition.

In one embodiment, the computer device obtains the task requirement speech, and performs speech recognition on the task requirement speech by using the trained speech recognition model, to obtain a first recognition text.

Operation S1012b: Text processing.

In one embodiment, the computer device performs post-processing on the first recognition text to obtain the task requirement information. The post-processing includes punctuation addition and spelling correction.

The post-processing includes punctuation addition, spelling correction, and the like.

Operation S1014b: Output the task requirement information.

Operation S1004a: Obtain a prompt corpus.

In one embodiment, the computer device may obtain, from a workflow corpus database, a prompt corpus constructed for a workflow, the prompt corpus including prompt information constructed for each atomic task of the workflow, and the prompt information including an executable structural body and application information of the atomic task.

Operation S1006a: Perform semantic interpretation according to the task requirement information and the prompt corpus, to obtain an executable structural body of a target task.

Operation S1006a is a process of calling a large language model each time, and each call is used as an example for description. For a specific process, refer to (c), that is, operation S1002c to operation S1010c:

Operation S1002c: Determine a call parameter of a current call according to the task requirement information and the prompt corpus; and historically call context information if the current call is a non-first call.

In one embodiment, the computer device uses a previous output result as context information of a current call (for example, if the current call is the second call, the context information of the current call is the second-level sub-requirement information; or if the current call is the third call, the context information of the current call is the third-level sub-requirement information), uses the context information of the current call, the prompt corpus, and a level prediction result corresponding to a previous call as a call parameter of the current call (if the current call is the second call, the level prediction result corresponding to the previous call is the first-level prediction result; or if the current call is the third call, the level prediction result corresponding to the previous call is the second-level prediction result).

Operation S1004c: Input the call parameter of the current call into the large language model, to obtain a level prediction result of the current call.

Operation S1006c: Determination of executable check.

In one embodiment, when it is verified that a format of the level prediction result of the current call is valid, the computer device performs executable check on the level prediction result of the current call. If the executable check is not passed, or the format of the level prediction result of the current call is invalid, operation S1008c is performed. If the executable check is passed, operation 1010c is performed.

Operation S1008c: Store a disassembly result of the current call in a database in a multi-level vector manner, and use the disassembly result as context information of a next call.

In one embodiment, the computer device disassembles the context information of the current call, to obtain a disassembly result of the current call. The disassembly result of the current call (for example, if the current call is the second call, the disassembly result of the current call is third-level sub-requirement information) is stored in the database in a manner of a multilevel vector, and used as context information of a next call.

Operation 1010c: Output the executable structural body of the target task.

In one embodiment, when it is verified that the format of the level prediction result of the current call is valid and the executable check is passed, the computer device determines the executable structural body of the target task according to the level prediction result of the current call and outputs the executable structural body of the target task.

For example, the large language model is called for the first time, and a first-level prediction result is outputted according to the task requirement information and the prompt corpus. After the first-level prediction result is obtained, format check is performed on the first-level prediction result. If a corresponding format check result indicates that the format check is passed, executable check is performed on the first-level prediction result, to obtain a first-level check result. If the format check result represents that the format check is not passed, the first-level prediction result is not a structural body, or the first-level prediction result is an invalid structural body. In this case, executable check does not need to be performed on the first-level prediction result, and the task requirement information is directly disassembled, to disassemble the task requirement information into a plurality of pieces of second-level sub-requirement information.

When the first-level check result indicates that the first-level prediction result includes an executable structural body, a target atomic task matching the task requirement information is directly obtained according to the first-level prediction result. The computer device disassembles, when the first-level check result indicates that the first-level prediction result excludes an executable structural body, the task requirement information into a plurality of pieces of second-level sub-requirement information. The large language model is called for the second time, and all of each piece of second-level sub-requirement information, the prompt corpus, and the first-level prediction result are inputted to the large language model. For each piece of second-level sub-requirement information, a second-level prediction result is outputted according to the second-level sub-requirement information, the prompt corpus, and the first-level prediction result by using the large language model. Format check is performed on the second-level prediction result. If a corresponding format check result indicates that the format check is passed, return to perform the operation of performing executable check on the second-level prediction result, to obtain a second-level check result. If a corresponding format check result represents that the format check is passed, it indicates that the second-level prediction result is a structural body, and a format of the structural body is valid. Target atomic tasks matching all the pieces of second-level sub-requirement information are obtained, and the computer device determines a concatenation sequence of respective target atomic tasks of the pieces of second-level sub-requirement information according to the disassembly sequence of the pieces of second-level sub-requirement information. The computer device sequentially concatenates, starting from a target atomic task of a first concatenation sequence, the respective target atomic tasks of the pieces of second-level sub-requirement information according to the concatenation sequence of respective target atomic tasks of the pieces of second-level sub-requirement information, to obtain one or more target atomic tasks matching the task requirement information.

If a corresponding format check result represents that the format check is not passed, the second-level prediction result is not a structural body, or the second-level prediction result is an invalid structural body. In this case, executable check does not need to be performed on the second-level prediction result, and the second-level sub-requirement information is directly disassembled, to disassemble the task requirement information into a plurality of pieces of third-level sub-requirement information.

For each piece of third-level sub-requirement information, the large language model is called again, and all of each piece of third-level sub-requirement information, the prompt corpus, and a second-level prediction result corresponding to each piece of second-level sub-requirement information are inputted to the large language model. For each third-level sub-requirement information, the computer device outputs a third-level prediction result corresponding to the third-level sub-requirement information according to the third-level sub-requirement information, the prompt corpus, and the second-level prediction result corresponding to the second-level sub-requirement information by using the large language model. When it is verified that a format of the third-level prediction result is valid, executable check is performed on the third-level prediction result, to obtain a third-level check result. If the third-level check result indicates that the corresponding third-level prediction result passes the executable check, a target atomic task matching the third-level sub-requirement information is obtained according to the third-level prediction result.

A concatenation sequence of target atomic tasks matching the pieces of third-level sub-requirement information is determined according to the disassembly sequence of the pieces of third-level sub-requirement information in the second disassembly. For each piece of second-level sub-requirement information, starting from a first target atomic task of a first concatenation sequence, the respective target atomic tasks of the pieces of third-level sub-requirement information are sequentially concatenated according to the concatenation sequence of respective target atomic tasks of the pieces of third-level sub-requirement information, to obtain one or more target atomic tasks of the second-level sub-requirement information. Starting from a first target atomic task of a second concatenation sequence, the respective target atomic tasks of the pieces of second-level sub-requirement information are sequentially concatenated according to the concatenation sequence of respective target atomic tasks of the pieces of second-level sub-requirement information, to obtain one or more target atomic tasks matching the task requirement information. The first concatenation sequence is a concatenation sequence of a first one of the target atomic tasks matching the third-level sub-requirement information. The second concatenation sequence is a concatenation sequence of a first one of the target atomic tasks matching the second-level sub-requirement information. An executable structural body of a target task matching the task requirement information is determined according to executable structural bodies of one or more target atomic tasks matching the task requirement information, and the executable structural body of the target task is outputted.

Operation S1008a: Execute the target task.

In one embodiment, a task execution flowchart of the target task is rendered and displayed in the interactive task generation interface, the target task being formed according to one or more target atomic tasks; and the computer device executes the target task; and updates, when an execution status of the target task is updated, the execution status of the target task in the task execution flowchart.

For a specific process of executing the target task, refer to (d), that is, operation S1002d to operation S1012d:

Operation S1002d: Create an execution instance corresponding to a task.

In one embodiment, the computer device directly triggers an execution instruction for executing the target task. In one embodiment, the computer device may store the executable structural body of the target task, and trigger execution of the target task after waiting for a preset period of time. In one embodiment, the computer device may trigger, in response to a trigger operation on the target task, an execution instruction for executing the target task. When the execution instruction for executing the target task is triggered, a task instance corresponding to the target task is created in a task instance table of a database.

Operation S1004d: Obtain and initialize the execution example.

In one embodiment, the computer device pushes a task instance ID corresponding to the created task instance to a task instance message queue, and monitors the task instance message queue. In one embodiment, the task instance message queue is monitored according to containers (which may be understood as distributed execution nodes) in a consumption cluster of a distributed workflow engine deployed in the computer device. Once new task instance IDs exist in the message queue, the new task instance IDs are sequentially consumed in a first-in-first-out sequence, and corresponding task instances are executed.

Operation S1006d: Obtain a sub-task instance table.

In one embodiment, when a task instance of a target task is consumed, the computer device pushes a sub-task instance ID corresponding to the first sub-task instance to a sub-task instance message queue; consumes a sub-task instance ID from the sub-task instance message queue; obtains a corresponding sub-task instance table according to the sub-task instance ID, and loads and executes a current sub-task instance; stores, after execution of the current sub-task instance is completed, the sub-task instance into the corresponding sub-task instance table in a database, and determines a sub-task instance to which the current sub-task instance points; and returns, after a sub-task instance ID corresponding to the pointed-to sub-task instance is pushed to the sub-task instance message queue, to continue performing the operation of consuming a sub-task instance ID from the sub-task instance message queue, until all the one or more sub-task instances of the task instance are executed completely.

After the sub-task instance to which the current sub-task instance points is determined, a sub-task instance table of the executed sub-task instance is obtained, and the pointed-to sub-task instance is persistently stored to a sub-task instance table of a database; initializes a running status of the sub-task instance to unprocessed; and updates the running status of the sub-task instance to being completed in the sub-task instance table after the sub-task instance is executed, and updates the execution data of the sub-task instance. When the current sub-task instance points to a plurality of sub-task instances, each of respective sub-task instance IDs of the plurality of pointed-to sub-task instances is pushed to the sub-task instance message queue; and the plurality of corresponding sub-task instances are concurrently loaded and executed after the plurality of sub-task instance IDs are consumed from the sub-task instance message queue by using distributed execution nodes. The method for processing the target task further includes: parsing the task instance, obtaining global variables of the included sub-task instances, and forming and storing a global variable table; the global variables including global input variables and global output variables; updating the global output variables in the global variable table according to corresponding execution data after the current sub-task instance is executed; and loading the updated global variable table, obtaining input data corresponding to the global input variable of the sub-task instance pointed to, and executing, according to the input data, the sub-task instance pointed to.

Operation S1008d: Parse a path syntax expression.

In one embodiment, in a process of sequentially executing the sub-task instances of the execution instance of the target task, if input data of one sub-task instance is output data of a previous sub-task instance before the sub-task instance, the input data of the sub-task instance may be obtained by parsing a path syntax expression, that is, the output data of the previous sub-task instance before the sub-task instance is obtained.

Operation S1010d: The computer device executes the sub-task instance according to the input data of the sub-task instance.

Operation S1012d: Determine whether the execution instance ends.

In one embodiment, the output data obtained after the execution is stored in the database, and whether the execution instance of the target task ends is determined, that is, whether all sub execution instances in the execution instance of the target task are executed completely is determined. If execution statuses of all the sub execution instances are executed, it is determined that the execution instance of the target task is completed.

Operation S1010a: Display an execution progress viewing link.

In one embodiment, when execution of the target task starts, the execution progress viewing link of the target task is displayed in the task generation interface, namely, the interactive task generation interface. A jump to an execution progress viewing interface is made in response to a trigger operation on the execution progress viewing link, and an execution progress of the target task is displayed in the execution progress viewing interface. Each time the target task executes an application, a task execution flowchart of the target task in the execution status is displayed in the execution progress viewing interface, and a sign of completed is displayed in an image corresponding to the completely executed application in the task execution flowchart of the target task in the execution status.

In this embodiment, the task requirement information inputted based on the interactive task generation interface is obtained, the large language model is directly called, the task requirement information is inputted into the large language model, and semantic interpretation is performed on the task requirement information by using the large language model, to automatically obtain the executable structural body of the target task matching the task requirement information. Graphic rendering is performed on the target task based on the executable structural body of the target task, to obtain the task execution flowchart of the target task, and the task execution flowchart is displayed in the task generation interface, the target task being formed according to the one or more target atomic tasks, so that detailed information of the generated target task can be visually displayed. The execution progress viewing link of the target task is displayed in the task generation interface, the execution progress viewing link being configured for viewing an execution progress of the target task, to make it convenient to view the execution progress visually in time. That is, the user can complete automatic generation of a task only by providing the task requirement information without performing any complex operation, thereby simplifying task generation operations, and improving task generation efficiency. In addition, during task generation, the running environment can be reused, different tasks can be executed, and the tasks can be executed concurrently, thereby effectively reducing costs. In a process of executing the target task, a fine-grained execution mechanism of an atomic task shock wave is performed, so that applications are executed concurrently. Execution of a workflow engine is close to a running characteristic (such as concurrent wait control) of coding and programming in a manner of concurrently aggregating applications. In addition, such a low-code design concept as an executable structural body DSL Json enables learning and use costs to be greatly reduced and efficiency to be greatly improved.

Although the operations are displayed sequentially according to the instructions of the arrows in the flowcharts involved in the embodiments as described above, these operations are not necessarily performed sequentially according to the sequence instructed by the arrows. Unless otherwise explicitly specified in this specification, execution of the operations is not strictly limited, and the operations may be performed in other sequences. Moreover, at least some of the operations in the flowcharts involved in the embodiments as described above may include a plurality of operations or a plurality of stages. These operations or stages are not necessarily performed at the same time, but may be performed at different times. These operations or stages are not necessarily performed in sequence, but may be performed in turn or in alternation with other operations or at least some of the operations or stages in other operations.

Based on the same inventive concept, an embodiment of the present disclosure further provides a task generation system based on a large language model for implementing the foregoing task generation method based on a large language model. An implementation for resolving problems provided in the system is similar to the implementation described in the foregoing method. Therefore, for specific limitations of the following one or more embodiments of the task generation system based on a large language model, reference may be made to the foregoing limitations to the task generation method based on a large language model. Details are not described herein again.

In an embodiment, as shown in FIG. 11, a task generation system 1100 based on a large language model is provided, including: an information obtaining module 1102, a structural body obtaining module 1104, a task execution flowchart display module 1106, and a link display module 1108, where
the information obtaining module is configured to obtain task requirement information inputted based on an interactive task generation interface;
the structural body obtaining module is configured to call a large language model, input the task requirement information into the large language model, and perform semantic interpretation on the task requirement information by using the large language model, to output an executable structural body of a target task matching the task requirement information;
the task execution flowchart display module is configured to perform graphic rendering on the target task based on the executable structural body of the target task, to obtain a task execution flowchart of the target task, and display the task execution flowchart in the task generation interface, the target task being formed according to one or more target atomic tasks; and
the link display module is configured to display an execution progress viewing link of the target task in the task generation interface, the execution progress viewing link being configured for viewing an execution progress of the target task. In some embodiments, the information obtaining module 1102 is configured to: display the task generation interface in which human-machine information interaction is performed; receive task content that is inputted by using the interactive task interface, and obtaining the task content; and perform semantic conversion on the task content, to obtain the task requirement information.

In some embodiments, the information obtaining module 1102 is configured to call a prompt corpus constructed for a workflow by using the large language model, perform semantic interpretation on the task requirement information, to obtain the executable structural body of the target task matching the task requirement information, and output the executable structural body of the target task, the prompt corpus including prompt information constructed for each atomic task of the workflow, and the prompt information including an executable structural body and application information of the atomic task.

In some embodiments, the structural body obtaining module 1104 is configured to: generate a call parameter according to the task requirement information and the prompt corpus; construct a model call request according to the call parameter; and call the large language model according to the model call request.

In some embodiments, the structural body obtaining module is configured to: perform semantic interpretation according to the task requirement information and the prompt corpus by using the large language model, to obtain one or more target atomic tasks matching the task requirement information; and obtain executable structural bodies of the one or more target atomic tasks from the prompt corpus, and obtain, according to the executable structural bodies of the one or more target atomic tasks, the executable structural body of the target task matching the task requirement information.

In some embodiments, the structural body obtaining module is configured to sequentially determine, according to the task requirement information and the prompt corpus by using the large language model, the one or more target atomic tasks matching the task requirement information; and the structural body obtaining module is configured to combine executable structural bodies of the one or more target atomic tasks according to next atomic task IDs indicated by respective executable structural bodies of the one or more target atomic tasks, to obtain the executable structural body of the target task matching the task requirement information.

In some embodiments, the structural body obtaining module is configured to: disassemble the task requirement information into a plurality of pieces of sub-requirement information by using the large language model; sequentially determine, for each piece of sub-requirement information according to the sub-requirement information and the prompt corpus, a target atomic task matching the sub-requirement information; and determine, according to the target atomic task matching each piece of sub-requirement information, the one or more target atomic tasks matching the task requirement information.

In some embodiments, the structural body obtaining module is configured to: obtain a first-level prediction result according to the task requirement information and the prompt corpus by using the large language model, and perform executable check on the first-level prediction result, to obtain a first-level check result; disassemble, when the first-level check result indicates that the first-level prediction result excludes an executable structural body, the task requirement information into a plurality of pieces of second-level sub-requirement information; output, for each piece of second-level sub-requirement information, a second-level prediction result according to the second-level sub-requirement information, the prompt corpus, and the first-level prediction result by using the large language model, and perform executable check on the second-level prediction result, to obtain a second-level check result; and determine, when the second-level check result indicates that the second-level prediction result includes an executable structural body, that the second-level prediction result passes the executable check, and obtain, according to the second-level prediction result, a target atomic task matching the second-level sub-requirement information.

In some embodiments, the structural body obtaining module is further configured to obtain, when the first-level check result indicates that the first-level prediction result includes an executable structural body, a target atomic task matching the task requirement information according to the first-level prediction result.

In some embodiments, the structural body obtaining module is further configured to: obtain target atomic tasks matching all the pieces of second-level sub-requirement information, and obtain a disassembly sequence of the pieces of second-level sub-requirement information; and concatenate the target atomic tasks matching all the pieces of second-level sub-requirement information according to the disassembly sequence of the pieces of second-level sub-requirement information, to obtain the one or more target atomic tasks matching the task requirement information.

In some embodiments, the structural body obtaining module is further configured to: disassemble, when the second-level prediction result corresponding to the second-level sub-requirement information does not pass the executable check, the second-level sub-requirement information into a plurality of pieces of third-level sub-requirement information; output, for each piece of third-level sub-requirement information, a third-level prediction result according to the third-level sub-requirement information, the prompt corpus, and the second-level prediction result corresponding to each piece of second-level sub-requirement information by using the large language model, and perform executable check on the third-level prediction result, to obtain a third-level check result; and determine, when the third-level check result indicates that the third-level prediction result includes an executable structural body, that the third-level prediction result passes the executable check, and obtain, according to the third-level prediction result, a target atomic task matching the third-level sub-requirement information.

In some embodiments, the structural body obtaining module is further configured to: obtain target atomic tasks matching all the pieces of third-level sub-requirement information, and obtain a disassembly sequence of the pieces of third-level sub-requirement information and a disassembly sequence of the pieces of second-level sub-requirement information; concatenate the target atomic tasks matching all the pieces of third-level sub-requirement information according to the disassembly sequence of the pieces of third-level sub-requirement information, to obtain one or more target atomic tasks matching the second-level sub-requirement information; and concatenate the target atomic tasks matching all the pieces of second-level sub-requirement information according to the disassembly sequence of the pieces of second-level sub-requirement information, to obtain the one or more target atomic tasks matching the task requirement information.

In some embodiments, the system further includes an update module. The update module is configured to: execute the target task; and update, when an execution status of the target task is updated, the execution status of the target task in the task execution flowchart.

In some embodiments, the update module is further configured to: jump to an execution progress viewing interface in response to a trigger operation on the execution progress viewing link; and display an execution progress of the target task in the execution progress viewing interface.

In some embodiments, the system further includes a task execution module. The task execution module is configured to: create a task instance about the target task when an execution instruction for executing the target task is triggered, the task instance including one or more sub-task instances, and the sub-task instance being configured for executing a corresponding target atomic task; and sequentially execute, from a first sub-task instance of the task instance, the one or more sub-task instances according to executable structural bodies of the one or more sub-task instances.

In some embodiments, the task execution module is further configured to: create a task instance corresponding to the target task in a task instance table of a database, the task instance table being configured for recording a task instance ID and a flow data structure of the task instance, and the flow data structure including a sub-task instance ID and a pointing relationship between the one or more sub-task instances; push the task instance ID to a task instance message queue; and perform, after the task instance ID is consumed from the task instance message queue, the operation of sequentially executing, from a first sub-task instance of the task instance, the one or more sub-task instances according to executable structural bodies of the one or more sub-task instances.

In some embodiments, the task execution module is further configured to: push a sub-task instance ID corresponding to the first sub-task instance to a sub-task instance message queue; consume a sub-task instance ID from the sub-task instance message queue; load a corresponding sub-task instance according to the sub-task instance ID, and execute the corresponding sub-task instance; determine, after the corresponding sub-task instance is executed, a sub-task instance to which the corresponding sub-task instance points; and return, after a sub-task instance ID corresponding to the pointed-to sub-task instance is pushed to the sub-task instance message queue, to continue performing the operation of consuming a sub-task instance ID from the sub-task instance message queue, until all the one or more sub-task instances of the task instance are executed completely.

In some embodiments, the task execution module is further configured to push, when the corresponding sub-task instance points to a plurality of sub-task instances, each of respective sub-task instance IDs of the plurality of pointed-to sub-task instances to the sub-task instance message queue; and the task execution module is further configured to concurrently load the plurality of corresponding sub-task instances after the plurality of sub-task instance IDs are consumed from the sub-task instance message queue by using distributed execution nodes, and execute the plurality of corresponding sub-task instances.

All or some of the modules in the foregoing task generation system based on a large language model may be implemented by software, hardware, and a combination thereof. The modules may be built in or stand alone from a processor in a computer device in the form of hardware, or may be stored in a memory in a computer device in the form of software, so that a processor ca call and execute operations corresponding to the modules.

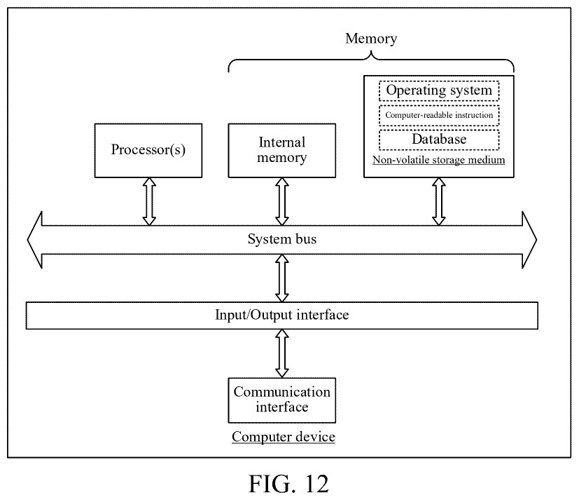

In an embodiment, a computer device is provided. The computer device may be a server or a terminal, and an internal structure diagram thereof may be shown in FIG. 12. The computer device includes a processor, a memory, an input/output (briefly referred to as 1/O) interface, and a communication interface. The processor, the memory, and the input/output interface are connected to each other by using a system bus, and the communication interface is connected to the system bus by using the input/output interface. The processor of the computer device is configured to provide calculation and control ability. The memory of the computer device includes a non-volatile storage medium and an internal memory. The non-volatile storage medium stores an operating system, computer readable instructions, and a database. The internal memory provides an operating environment for the operating system and the computer-readable instructions in the non-volatile storage medium. The input/output interface of the computer device is configured to exchange information between the processor and the external device. The communication interface of the computer device is configured to connect and communicate with an external terminal via a network. The computer-readable instructions, when executed by the processor, implement a task generation method based on a large language model.

A person skilled in the art may understand that, the structure shown in FIG. 12 is merely a block diagram of a partial structure related to the solution in the present disclosure, and does not constitute a limitation on the computer device to which the solution in the present disclosure is applied. Specifically, the computer device may include more components or fewer components than those shown in the figure, or some merged components, or different component arrangements.

In an embodiment, a computer device is further provided, including a memory and a processor, the memory having computer-readable instructions stored therein, the processor, when executing the computer-readable instructions, being configured for implementing the operations in the foregoing method embodiments.

In an embodiment, a computer-readable storage medium is provided, and stores computer-readable instructions. The computer-readable instructions, when executed by the processor, perform the operations of the foregoing method embodiments.

In an embodiment, a computer program product is provided, including computer-readable instructions. The computer-readable instructions, when executed by a processor, implements the operations in the foregoing method embodiments.

User information (including, but not limited to, user equipment information, user personal information, and the like) and data (including, but not limited to, data for analysis, stored data, displayed data, and the like) involved in the present disclosure are all information and data authorized by users or fully authorized by all parties, and collection, use, and processing of relevant data need to comply with relevant laws, regulations, and standards of relevant countries and regions.

Those of ordinary skill in the art may understand that all or some of the operations of the method according to the foregoing embodiments may be implemented by computer-readable instructions instructing relevant hardware. The computer-readable instructions may be stored in a non-volatile computer-readable storage medium. When the computer-readable instructions are executed, the operations of the method according to the foregoing embodiments may be included. References to the memory, the database, or other medium used in the embodiments provided in the present disclosure may all include at least one of a non-volatile memory and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random-access memory (MRAM), a ferroelectric random-access memory (FRAM), a phase change memory (PCM), a graphene memory, and the like. The volatile memory may include a random-access memory (RAM) and an external cache. For the purpose of illustration but not limitation, RAM is available in many forms, for example, static random access memory (SRAM) or dynamic random access memory (DRAM), and so on. The databases involved in various embodiments provided in the present disclosure may include at least one of a relational database and a non-relational database. The non-relational database may include, but is not limited to, a blockchain-based distributed database and the like. The processors involved in the various embodiments provided by the present disclosure can be general-purpose processors, central processing units, graphics processors, digital signal processors, programmable logic devices, data processing logic devices based on quantum computing, and are not limited thereto.

Technical features in the foregoing embodiments may be combined in different manners to form other embodiments. To make descriptions concise, not all possible combinations of the technical features in the foregoing embodiments are described. However, the combinations of the technical features shall be considered as falling within the scope described in this specification, provided that no conflict exists.

The foregoing embodiments only describe several implementations of the present disclosure, which are described specifically and in detail, but cannot be construed as a limitation to the patent scope of the present disclosure. A person of ordinary skill in the art may further make several variations and improvements without departing from the ideas of the present disclosure, and such variations and improvements all fall within the protection scope of the present disclosure. Therefore, the protection scope of the present disclosure shall be subject to the appended claims.

What is claimed is:

1. A task generation method, performed by a computer device, the method comprising:
obtaining task requirement information inputted based on a task generation interface;
calling a large language model, and inputting the task requirement information into the large language model for performing semantic interpretation on the task requirement information and outputting an executable structural body of a target task that matches the task requirement information;
performing graphic rendering on the target task based on the executable structural body of the target task, to obtain a task execution flowchart of the target task, and displaying the task execution flowchart in the task generation interface, the target task being formed according to one or more target atomic tasks; and
displaying an execution progress viewing link of the target task in the task generation interface, the execution progress viewing link being configured for viewing an execution progress of the target task.

2. The method according to claim 1, wherein obtaining the task requirement information inputted based on the task generation interface comprises:
displaying the task generation interface that allows human-machine information interaction;
receiving task content that is inputted by using the task generation interface, and obtaining the task content; and
performing semantic conversion on the task content, to obtain the task requirement information.

3. The method according to claim 1, wherein performing the semantic interpretation on the task requirement information by using the large language model comprises:
calling a prompt corpus constructed for a workflow by using the large language model, performing the semantic interpretation on the task requirement information, to obtain the executable structural body of the target task that matches the task requirement information, and outputting the executable structural body of the target task, the prompt corpus comprising prompt information constructed for an atomic task of the workflow, and the prompt information comprising an executable structural body and application information of the atomic task.

4. The method according to claim 3, wherein calling the large language model comprises:
generating a call parameter according to the task requirement information and the prompt corpus;
constructing a model call request according to the call parameter; and
calling the large language model according to the model call request.

5. The method according to claim 3, wherein calling the prompt corpus constructed for the workflow by using the large language model, and performing the semantic interpretation on the task requirement information, to obtain the executable structural body of the target task matching the task requirement information comprises:
performing the semantic interpretation according to the task requirement information and the prompt corpus by using the large language model, to obtain one or more target atomic tasks matching the task requirement information; and
obtaining one or more executable structural bodies of the one or more target atomic tasks from the prompt corpus, and obtaining, according to the one or more executable structural bodies of the one or more target atomic tasks, the executable structural body of the target task matching the task requirement information.

6. The method according to claim 5, wherein performing the semantic interpretation according to the task requirement information and the prompt corpus by using the large language model, to obtain the one or more target atomic tasks matching the task requirement information comprises:
sequentially determining, according to the task requirement information and the prompt corpus by using the large language model, the one or more target atomic tasks matching the task requirement information; and
obtaining, according to the one or more executable structural bodies of the one or more target atomic tasks, the executable structural body of the target task matching the task requirement information comprises:
combining the one or more executable structural bodies of the one or more target atomic tasks according to next atomic task identifiers (IDs) indicated by respective executable structural bodies of the one or more target atomic tasks, to obtain the executable structural body of the target task matching the task requirement information.

7. The method according to claim 6, wherein sequentially determining, according to the task requirement information and the prompt corpus by using the large language model, the one or more target atomic tasks matching the task requirement information comprises:
disassembling the task requirement information into a plurality of pieces of sub-requirement information by using the large language model;
sequentially determining, for a piece of sub-requirement information according to the sub-requirement information and the prompt corpus, a target atomic task matching the sub-requirement information; and
determining, according to the target atomic task matching the piece of sub-requirement information, the one or more target atomic tasks matching the task requirement information.

8. The method according to claim 7, wherein disassembling the task requirement information into the plurality of pieces of sub-requirement information by using the large language model; and sequentially determining, for the piece of sub-requirement information according to the sub-requirement information and the prompt corpus, the target atomic task matching the sub-requirement information comprises:
obtaining a first-level prediction result according to the task requirement information and the prompt corpus by using the large language model, and performing executable check on the first-level prediction result, to obtain a first-level check result;
disassembling, when the first-level check result indicates that the first-level prediction result excludes an executable structural body, the task requirement information into a plurality of pieces of second-level sub-requirement information;
outputting, for a piece of second-level sub-requirement information, a second-level prediction result according to the second-level sub-requirement information, the prompt corpus, and the first-level prediction result by using the large language model, and performing executable check on the second-level prediction result, to obtain a second-level check result; and
determining, when the second-level check result indicates that the second-level prediction result comprises an executable structural body, that the second-level prediction result passes the executable check, and obtaining, according to the second-level prediction result, a target atomic task matching the second-level sub-requirement information.

9. The method according to claim 8, further comprising:
obtaining, when the first-level check result indicates that the first-level prediction result comprises an executable structural body, a target atomic task matching the task requirement information according to the first-level prediction result.

10. The method according to claim 8, wherein determining, according to the target atomic task matching the piece of sub-requirement information, the one or more target atomic tasks matching the task requirement information comprises:
obtaining target atomic tasks matching all pieces of second-level sub-requirement information, and obtaining a disassembly sequence of the pieces of second-level sub-requirement information; and
concatenating the target atomic tasks matching all the pieces of second-level sub-requirement information according to the disassembly sequence of the pieces of second-level sub-requirement information, to obtain the one or more target atomic tasks matching the task requirement information.

11. The method according to claim 10, further comprising:
disassembling, when the second-level prediction result corresponding to the second-level sub-requirement information does not pass the executable check, the second-level sub-requirement information into a plurality of pieces of third-level sub-requirement information;
outputting, for a piece of third-level sub-requirement information, a third-level prediction result according to the third-level sub-requirement information, the prompt corpus, and the second-level prediction result corresponding to a piece of second-level sub-requirement information by using the large language model, and performing executable check on the third-level prediction result, to obtain a third-level check result; and
determining, when the third-level check result indicates that the third-level prediction result comprises an executable structural body, that the third-level prediction result passes the executable check, and obtaining, according to the third-level prediction result, a target atomic task matching the third-level sub-requirement information.

12. The method according to claim 11, wherein determining, according to the target atomic task matching the piece of sub-requirement information, the one or more target atomic tasks matching the task requirement information comprises:
obtaining target atomic tasks matching all pieces of third-level sub-requirement information, and obtaining a disassembly sequence of the pieces of third-level sub-requirement information and a disassembly sequence of the pieces of second-level sub-requirement information;
concatenating the target atomic tasks matching all the pieces of third-level sub-requirement information according to the disassembly sequence of the pieces of third-level sub-requirement information, to obtain one or more target atomic tasks matching the second-level sub-requirement information; and
concatenating the target atomic tasks matching all the pieces of second-level sub-requirement information according to the disassembly sequence of the pieces of second-level sub-requirement information, to obtain the one or more target atomic tasks matching the task requirement information.

13. The method according to claim 1, further comprising:
executing the target task; and
updating, when an execution status of the target task is updated, the execution status of the target task in the task execution flowchart.

14. The method according to claim 13, further comprising:
jumping to an execution progress viewing interface in response to a trigger operation on the execution progress viewing link; and
displaying an execution progress of the target task in the execution progress viewing interface.

15. The method according to claim 13, wherein executing the target task comprises:
creating a task instance about the target task when an execution instruction for executing the target task is triggered, the task instance comprising one or more sub-task instances, and the sub-task instance being configured for executing a corresponding target atomic task; and
sequentially executing, from a first sub-task instance of the task instance, the one or more sub-task instances according to executable structural bodies of the one or more sub-task instances.

16. The method according to claim 15, further comprising:
creating a task instance corresponding to the target task in a task instance table of a database, the task instance table being configured for recording a task instance ID and a flow data structure of the task instance, and the flow data structure comprising a sub-task instance ID and a pointing relationship between the one or more sub-task instances; and
pushing the task instance ID to a task instance message queue, followed by
performing, after the task instance ID is consumed from the task instance message queue, the operation of sequentially executing, from the first sub-task instance of the task instance, the one or more sub-task instances according to the executable structural bodies of the one or more sub-task instances.

17. The method according to claim 16, wherein sequentially executing, from the first sub-task instance of the task instance, the one or more sub-task instances according to the executable structural bodies of the one or more sub-task instances comprises:
pushing a sub-task instance ID corresponding to the first sub-task instance to a sub-task instance message queue;
consuming a sub-task instance ID from the sub-task instance message queue;
loading a corresponding sub-task instance according to the sub-task instance ID, and executing the corresponding sub-task instance;
determining, after the corresponding sub-task instance is executed, a sub-task instance to which the corresponding sub-task instance points; and
returning, after a sub-task instance ID corresponding to the pointed-to sub-task instance is pushed to the sub-task instance message queue, to continue performing the operation of consuming a sub-task instance ID from the sub-task instance message queue, until all the one or more sub-task instances of the task instance are executed completely.

18. The method according to claim 17, wherein pushing the sub-task instance ID corresponding to the pointed-to sub-task instance to the sub-task instance message queue comprises:
pushing, when the corresponding sub-task instance points to a plurality of sub-task instances, each of respective sub-task instance IDs of the plurality of pointed-to sub-task instances to the sub-task instance message queue; and
consuming the sub-task instance ID from the sub-task instance message queue comprises:
concurrently loading the plurality of corresponding sub-task instances after the plurality of sub-task instance IDs are consumed from the sub-task instance message queue by using distributed execution nodes, and executing the plurality of corresponding sub-task instances.

19. A computer device, comprising one or more processors and a memory containing computer-readable instructions that, when being executed, cause the one or more processors to perform:
obtaining task requirement information inputted based on a task generation interface;
calling a large language model, and inputting the task requirement information into the large language model for performing semantic interpretation on the task requirement information and outputting an executable structural body of a target task that matches the task requirement information;
performing graphic rendering on the target task based on the executable structural body of the target task, to obtain a task execution flowchart of the target task, and displaying the task execution flowchart in the task generation interface, the target task being formed according to one or more target atomic tasks; and
displaying an execution progress viewing link of the target task in the task generation interface, the execution progress viewing link being configured for viewing an execution progress of the target task.

20. A non-transitory computer-readable storage medium containing computer-readable instructions that, when being executed, cause at least one processor to perform:
obtaining task requirement information inputted based on a task generation interface;
calling a large language model, and inputting the task requirement information into the large language model for performing semantic interpretation on the task requirement information and outputting an executable structural body of a target task that matches the task requirement information;
performing graphic rendering on the target task based on the executable structural body of the target task, to obtain a task execution flowchart of the target task, and displaying the task execution flowchart in the task generation interface, the target task being formed according to one or more target atomic tasks; and
displaying an execution progress viewing link of the target task in the task generation interface, the execution progress viewing link being configured for viewing an execution progress of the target task.
